(19) United States
(12) Patent Application Publication
(10) Pub. No.: US 2017/0236130 A1
(43) Pub. Date: Aug. 17, 2017

(54) Emulating Manual System of Filing Using Electronic Document and Electronic File

(71) Applicant: Kim Seng KEE, Kuala Lumpur (MY)

(72) Inventors: Kim Seng Kee, Kuala Lumpur (MY); Keong Hway Chhua, Kuala Lumpur (MY)

(21) Appl. No.: 15/519,075

(22) PCT Filed: Oct. 13, 2015
(86) PCT No.: PCT/MY2015/050122

§ 371 Date: Apr. 13, 2017

(30) Foreign Application Priority Data
Oct. 13, 2014 (MY) PI2014703012

(51) Int. Cl. G06Q 30/00; G06Q 10/06; G06F 17/30

(52) U.S. Cl. CPC G06Q 30/018; G06F 17/30011; G06Q 10/06316

(57) ABSTRACT

A system to emulate manual filing system by storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); a Extraction Module (3) for extracting the Electronic Document Identifier (eDoc-Identifier), Section, Rowtype and Column of Electronic Document (eDoc) (11) generated by the String Module (2) for retrieval process; a Electronic Form (eForm) Generator Module to create at least one Electronic Form (eForm) having a Predefined Program based on a Electronic Dictionary (eDict) data; a Flow Diagram having pre-compiled task program set by at least one user; a Electronic Business Processing Module (eBPM) Generator to generate at least one task program based on the Flow Diagram to be stored into the Electronic Document (eDoc); a Mapping Generator Module to generate data mapping program based on a graphical information; a Transaction Processing Module to store the generated Mapping Program; a System Generator Module to generate process control and business rules into pre-compiled program using Electronic Business Processing Module (eBPM); a Virtual Memory for storing the Electronic Document (eDoc); and a Web-Read Module (4) for retrieving the Electronic Document (eDoc) from the Virtual Memory based on at least one identifier of Electronic Document (eDoc), in which the identifier is extracted based on the captured data entry of Electronic Form (eForm).

### FIELD OF INVENTION

The proposed invention relates to a system and method to emulate manual filing system by storing and processing document that operates on Relational Database Management System (RDBMS) having pluralities of modules to enable fast software development.

### BACKGROUND ART

An age of integration—in which data, images, audio and video are used together, often in the same document or process—has generated a real need for an efficient, seamless and intuitive means of storing and retrieving all this digital information. This usually means having to manage complex relationships between stored entities. Traditional methods involve breaking up and placing parts of the data into various tables so that a relational database management system (RDBMS) can handle them: this highly complex task involves designing and managing relationships between data items stored in the various tables.

Software development for enterprise is complex and time consuming as it may require hundreds of man years. The main contributor to complexity is the tens of thousands of tables necessary in an enterprise system. The design of the database together with the primary and foreign keys complicates SDLC. Also tables require extra programs to link and split documents.

The legacy system that uses RDBMS as its database cannot store documents and folios, the documents and folios must be split into tables with different primary keys and foreign keys to be able to store onto RDBMS. The thousands of table designs must include all input tables, intermediate tables and output tables is a very complicated undertaking.

The thousands of tables complicate systems development life cycle (SDLC) & complicates data managements. Therefore, to provide a one view of customer folio, general ledger folio, stock folio, etc. is a difficult effort as the data must be transformed between each process (web, transmission, storage, processing (batch, on-line, BPM), data-warehousing, data-mining, output.

In Legacy system, it is difficult to integrate data & system because it is usually developed by different group as Legacy systems involve thousands of tables. The Documents, Flows, Business Rules & Codes are often lost in the process, therefore difficult for business personnel to talk to the computer people.

Because of the complexity, software changes are slow, complex & expensive, the dateline are difficult to meet. What is really needed is an efficient system which stores structured, semi-structured and unstructured data (and the schema which describes the data), and manages the relationships between data items.

Therefore an invention is proposed a system to emulate manual filing system by storing and processing electronic document that operates on Relational Database Management System (RDBM).

### SUMMARY OF INVENTION

The present invention provides a system to emulate manual filing system by storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); a Extraction Module (3) for extracting the Electronic Document Identifier (eDoc-Identifier), Section, Rowtype and Column of Electronic Document (eDoc) (11) generated by the String Module (2) for retrieval process; a Electronic Form (eForm) Generator Module to create at least one Electronic Form (eForm) having a Predefined Program based on a Electronic Dictionary (eDict) data; a Flow Diagram having pre-compiled task program set by at least one user; a Electronic Business Processing Module (eBPM) Generator to generate at least one task program based on the Flow Diagram to be stored into the Electronic Document (eDoc); a Mapping Generator Module to generate data mapping program based on a graphical information; a Transaction Processing Module to store the generated Mapping Program; a System Generator Module to generate process control and business rules into pre-compiled program using Electronic Business Processing Module (eBPM); a Virtual Memory for storing the Electronic Document (eDoc); and a Web-Read Module (4) for retrieving the Electronic Document (eDoc) from the Virtual Memory based on at least one identifier of Electronic Document (eDoc), in which the identifier is extracted based on the captured data entry of Electronic Form (eForm).

Further, the system includes a Online Processing Module to ensure that a total sum of the transactions stored in the Transaction eLedger is equals to the sum of the transactions stored in Master eLedger.

Further, the system includes a Communication Processing Module to identify the requested Electronic Document (eDoc) based on at least one Row Identifier.

Further, the system includes a Online Processing Module to ensure that a total sum of the transactions stored in the Transaction eLedger is equals to the sum of the transactions stored in Master eLedger.

Further, the system includes a Batch Processing Module to sum the balance of each transaction from a batch of eDocs and compare the total sum with the pre-summed value from the batch header of eDocs.

Further, the system includes a Electronic Business Processing Module (eBPM) to identify and assign at least one task sequences based on master system flow information from Ledger Identifier and Document Identifier and storing into Electronic Filing (eFiling) system.

Further, the system includes a Parallel Processing Module to distribute databases based-on the last, last 2 or last 3 digit(s) of the account number.

Further, the system includes a Transaction Processing Module to ensure that the eDocs stored into the database are Sarbanes-Oxley (SOX) compliance.

Further, the system includes a Web processing Module to interpret program in the Program Module based on the Electronic Form (eForm) to display the requested Electronic Document (eDoc) that compatible with loading eForm.

Preferably, the Web-Read Module (4) for retrieving the Electronic Document (eDoc), further comprising; a Paging Module having the Electronic Document (eDoc) append into at least one Electronic File (eFile) in the RDBMS according to a predefined Page limit; a Index Module having at least one Index for the Electronic File (eFile) based-on document identifier, date, end sequence number, document status, document offset and document length; and a Read Module to obtain the Index and at least one Data Relative Page of the Electronic File (eFile) from the Index Module based on the identifier, in which the Electronic Document (eDoc) retrieved from the Paging Module based on the retrieved Index and Data Relative Page to be stored in the Virtual Memory and update the Index Module.

Further, the system includes a Storage Processing Module used for storing transaction (eDoc) into database through the Paging Module and Index Module.

Further, the system includes; a Emulating Manual System (eMS) platform (2) connected to the relational table-based design platform (1) through a Exchange Module (3) via a communication network, wherein the Exchange Module (3) provides two ways conversion between table-based file format of the relational table-based design platform (1) and Electronic Document (eDoc) of the eMS platform (2) so that either one of the platforms can process data of the other platform.

Preferably, the identifier of Electronic Document (eDoc) comprising document identifier, date, end sequence number, document status, document offset and document length.

Preferably, the list form having at least one predefined information for each document.

Preferably, the Enquiry Module, further comprising a Editing Module to load the retrieved Electronic Document (eDoc) for updating the retrieved Electronic Document (eDoc) and store at least one Updated Data to the Virtual Memory.

Preferably, the Enquiry Module, further comprising a Viewing Module to load the retrieved Electronic Document (eDoc) for viewing the retrieved Electronic Document (eDoc).

Preferably, the Enquiry Module further includes a Searching Module, wherein the Searching Module retrieves the Electronic Document (eDoc) using the Web-Read Module (4) based-on at least one Index, in which the index is retrieved from the identifier of Electronic Document (eDoc) comprising document identifier, date, end sequence number, document status, document offset and document length.

Preferably, the Web-Read Module (4) further includes a Uploading Module to upload the Electronic Document (eDoc) based the identifier of Electronic Document (eDoc), in which the Uploading Module establish connection to at least one server having RDBMS and update the RDBMS with the uploaded Electronic Document (eDoc).

Another aspect of present invention provides a method to emulate manual filing system by storing and processing document that operates on Relational Database Management System (RDBMS), comprising steps of; creating a template using a String Template (1) by defining a new document and indicate number of sections and number of rows required, which will be defined by an input from a user or a database. generating a Electronic Document (eDoc) (11) having at least one Electronic Document Identifier (eDoc-Identifier), Section and Rowtype by validating the document number, number of sections and number of rows based on the String Template (1) using a String Module (2); and extracting the Electronic Document Identifier (eDoc-Identifier), Section and Rowtype of Electronic Document (eDoc) (11) generated by the String Module (2) for retrieval process using a Extraction Module (3); obtaining at least one identifier of Electronic Document (eDoc) (11); validating if there is at least one Electronic Document (eDoc) (11) based on the identifier in at least one Virtual Memory using a Web-Read Module (4); and retrieving the validated Electronic Document (eDoc) (11) from the Virtual Memory, If there is Electronic Document (eDoc) (11) in the Virtual Memory.

A further aspect of present invention provides a method to emulate manual filing system by storing and processing document that operates on Relational Database Management System (RDBMS), comprising steps of; retrieving at least one Retrieved Data from the data of Electronic Document (eDoc) (11) stored in the database based on at least one Input of the Section, Rowtype and Column using a Retrieval Module (4); updating the Retrieved Data of Electronic Document (eDoc) (11) and store at least one Updated Data to the database based on the Input of Section, Rowtype and Column defined using a Updating Module (5); and forming the updated Electronic Document (eDoc) (11) by retrieving the Updated Data based on the Input of Section, Rowtype and Column using a Formation Module (6).

Further, the method includes a Mapping Module having Mapping Input further comprising; defining the Electronic File (eFile) (13) location using at least one Mapping Instruction having predefined mapping instruction; and updating the Retrieved Data of Electronic Document (eDoc) (11) using at least one Source Data.

A further aspect of present invention provides a method to emulate manual filing system by storing and processing document that operates on Relational Database Management System (RDBMS), comprising steps of; retrieving predefined Program (eProgram) using a Program Module from database;

loading the predefined Program it into at least one Electronic Form (eForm) to enable data entry of at least one user input (101); verifying if eDoc available to load the eDoc data in the eForm based on the user input (102); extracting the data entry of user input from the eForm (104); verifying the extracted data entry using a Program Module based on a set of rules that assist user on entering valid data and a verification tools that assist manipulating eForm and eDoc (104); saving the verified data into a eDoc (105); verifying if the saved eDoc has at least one Flow Control program defined by eBPM; submitting the saved eDoc to eBFS to define at least one Flow Control (108); transferring the defined eDoc to a Transaction Processing Module to regulate the eDoc to be in Sarbanes-Oxley (SOX) compliance; and storing the eDoc in to a database.

A further aspect of present invention provides a method to emulate manual filing system by storing and processing document that operates on Relational Database Management System (RDBMS), includes Communication Processing Module, further comprising steps of; receiving eDoc to start the process (501); identifying the process from row identifier that stated in the eDoc using Retrieval Module (502); validating the process from row identifier (503); triggering error message, If not valid request (504); and directing the eDoc to the requested process, If valid process (505).

A further aspect of present invention provides a method to emulate manual filing system by storing and processing document that operates on Relational Database Management System (RDBMS), includes Online Processing Module, comprising steps of; receive ledger identifier, document identifier, date and time to start the process (601); delaying the process till the predefined date and time (602); summing the data of predefined field(s) from eDocs from the predefined document identifier in Transaction eLedger (LT10) and Master eLedger(LM) based on the last processed date and time; retrieving the eDoc using the Read Module and each field(s) from eDocs are retrieved using the Retrieval Module (603); compares the summed value (604); validating if the summed value(s) from LT10 and LM is/are tally (605); locating the missing eDoc in LM from LT10 and store and update the missing eDoc into LM through Transaction Processing Module; and updating the process completion date and time to the process log, if summed value(s) tally, (607).

A further aspect of present invention provides a method to emulate manual filing system by storing and processing document that operates on Relational Database Management System (RDBMS), includes Batch Processing Module, comprising steps of; obtain a batch of eDocs (701); extract pre-summed balance(s) from the batch header for later comparison (702); summing the data of predefined field(s) from eDocs. Each field(s) from eDocs are retrieved using the Retrieval Module (703); comparing the summed value(s) with pre-summed balance(s) (704); validating if the summed value(s) and pre-summed balance(s) is/are tally (705); storing the entire batch of eDocs to Transaction Ledger (LT10) and Master Ledger (LM) using Transaction Processing Module, if summed value(s) and pre-summed balance(s) are tally (706); and prompting output error, if summed value(s) and pre-summed balance(s) is/are not tally (707).

A further aspect of present invention provides a method to emulate manual filing system by storing and processing document that operates on Relational Database Management System (RDBMS), includes Storage Processing Module, comprising steps of; obtaining at least one Index and at least one Data Relative Page of a Electronic File (eFile) having document identifier, date, end sequence number, document status, document offset and document length from a Index Module based on the identifier; retrieving the Electronic Document (eDoc) from a Paging Module based on the Index and Data Relative Page in the RDBMS; storing the Electronic Document (eDoc) in the Virtual Memory; and updating the Index Module.

A further aspect of present invention provides a method to emulate manual filing system by storing and processing document that operates on Relational Database Management System (RDBMS), includes Enquiry Processing Module, comprising steps of; retrieving a pluralities of Electronic Document (eDoc) information based on at least one Information for the Electronic Document Identifier (eDoc-Identifier), Section, Rowtype and Column of Electronic Document (eDoc) using a Enquiry Module; and displaying the retrieved Electronic Document (eDoc) information having at least one file history into at least one list form.

A further aspect of present invention provides a method to emulate manual filing system by storing and processing document that operates on Relational Database Management System (RDBMS), includes Parallel Processing Module, comprising steps of; receiving instruction either to create 10, 100 or 1000 databases and ledger identifier to be processed from a program (2201); creating databases based on the input instruction (2202); distributing eDocs from the defined ledger to databases created based last 2 or last 3 digit(s) of account number is used to determine which database the eDoc to be distributed using Paging and Index Module (2203); initiate parallel processing once all eDocs have been distributed into the designated databases (2204); and updating the processed result to the predefined Control eLedger through the Mapping Module (2205).

A further aspect of present invention provides a method to emulate manual filing system by storing and processing document that operates on Relational Database Management System (RDBMS), includes Mapping Processing Module, comprising steps of; receiving source eDoc from a program (2301); parsing source eDoc for later operation using Extraction Module (2302); identifying and loading destination eDoc from the source eDoc (for later updating) using Read Module (2303); loading a predetermined mapping instructions (2304); validating if there are more mapping instruction (2305);

validating if the data of the predetermined source column fulfill the predetermined requirement(s) from the mapping instruction, if there are more mapping instruction (2306); performing computation on the data of the predetermined source column from the mapping instruction, if the data of the predetermined source column fulfill the predetermined requirement(s) from the mapping instruction, then (2307); and storing the updated destination eDoc back into database using Paging and Index Modules (2309).

A further aspect of present invention provides a method to emulate manual filing system by storing and processing document that operates on Relational Database Management System (RDBMS), includes Mapping Processing Module, comprising steps of; receiving eDoc from a program (2401); store received eDoc into Transaction eFile using Paging and Indexing Module (2402); update received eDoc to Transaction eLedger using Paging and Indexing Module (2403); verifying if Transaction eLedger updated successfully (2404); storing the received eDoc into Master eFile using Paging and Indexing Module, if received eDoc updated successfully (2405); updating received eDoc to Master eLedger using Mapping Module (2406); verifying if Master eLedger updated successfully (2407); and returning the update status, if Master eLedger updated successfully (2408).

A further aspect of present invention provides a method to emulate manual filing system by storing and processing document that operates on Relational Database Management System (RDBMS), comprising steps of; obtaining a login authentication based on at least one user input; validating the login authentication of the user with at least one login details in a database; retrieving at least one user security matrix information of the valid user stored in the database; and displaying a menu having at least one list of predefined program stored in the database based on the user security matrix information.

A further aspect of present invention provides a method to emulate manual filing system by storing and processing document that operates on Relational Database Management System (RDBMS), wherein displaying at least one selection menu stored in the database based on the user's security matrix information, further comprising steps of; loading at least one Electronic Business Processing Module (eBPM) Generator having a predefined program, if the user selected from the displayed menu; loading at least one Electronic Form (eForm) Generator Module having a predefined program, if the user selected from the displayed menu; and logging out and update the logout request time to the database, if the user selected from the displayed menu.

A further aspect of present invention provides a method to emulate manual filing system by storing and processing document that operates on Relational Database Management System (RDBMS), wherein Loading at least one Electronic Business Processing Module (eBPM) Generator having a predefined program, further comprising steps of; displaying a menu having at least one list of predefined program stored in the Electronic Business Processing Module (eBPM) Generator; creating at least one workflow program, if the user selected from the displayed menu; saving the workflow program, if the user selected from the displayed menu; loading at least one predefined workflow program, if user selected from the displayed menu; and exiting the predefined program of Electronic Business Processing Module (eBPM) Generator, if the user selected from displayed menu.

A further aspect of present invention provides a method to emulate manual filing system by storing and processing document that operates on Relational Database Management System (RDBMS), comprising steps of; displaying a menu having Start Component, End Component, Condition Component, Flow Component and Save Component stored in the database; generating a Start Component for workflow program based the user input, if the user selected from the displayed menu; generating a End Component for workflow program based the user input, if the user selected from the displayed menu; generating at least one Condition Component for workflow program based the user input, if the user selected from the displayed menu; generating at least one Flow Component for workflow program based the user input, if the user selected from the displayed menu; and saving the generated components for workflow program, if the user selected from the displayed menu.

A further aspect of present invention provides a method to emulate manual filing system by storing and processing document that operates on Relational Database Management System (RDBMS), includes saving the workflow program, further comprising steps of; extracting flow information from the workflow diagram; generating a graphical information from the flow information; storing the graphical information by using the Transaction Processing Module; generating a predefined program for at least one task of graphical information; integrating a mapping information for the task of graphical information using the Transaction Processing Module; and storing the mapped task using the Transaction Processing Module.

A further aspect of present invention provides a method to emulate manual filing system by storing and processing document that operates on Relational Database Management System (RDBMS), includes loading at least one predefined workflow program, further comprising steps of; displaying a menu having Design Program, Metering Program and View Program stored in the workflow program; authorizing the user to edit at least one predefined task properties stored in the workflow program, if the user selected the Design Program from displayed menu; verifying operational workflow for the predefined task using a Retrieval Module, if the user selected the Metering Program from displayed menu; and displaying all of the predefined task, if the user selected the View Program from displayed menu.

A further aspect of present invention provides a method to emulate manual filing system by storing and processing document that operates on Relational Database Management System (RDBMS), comprising steps of; receiving the mapping instruction from a Mapping Program; extracting a mapping instruction contains mapping level, Source and Destination Row Identifier; interpreting the mapping instruction if the mapping is at Row or Column level of mapping level; validating if the mapping is at Row level; retrieving a Source and Destination Row eDicts using Read Module, if there is mapping at Row level; identifying a matching Source and Destination Column Name between the retrieved Source and Destination Row eDicts; verifying, if Source and Destination Column Name are matched; adding the matching Source and Destination Column pair into a temporally list, if Source and Destination Column Name are matched; validating if there are more column to match; validating if the mapping is at Column level; retrieving the Source and Destination Row eDicts using Read Module, if the mapping is at Column level; translating the Column Name into actual index based on the Row eDict retrieved; generating the Mapping Program using the identified Source and Destination index; generating at least one Condition and Computation based on mapping instruction received; and storing the generated Mapping Program to the database using Transaction Processing Module.

A further aspect of present invention provides a method to emulate manual filing system by storing and processing document that operates on Relational Database Management System (RDBMS), comprising the steps of: receiving request from either a relational table-based design platform (1) or a Emulating Manual System (eMS) platform (2); retrieving, by the Exchange Module (3), data for conversion from a database server, retrieving, by the Exchange Module (3), a suitable type of converter from the database server; and converting, by the Exchange Module (3), the format of the retrieved data into a designated format based on the received request.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

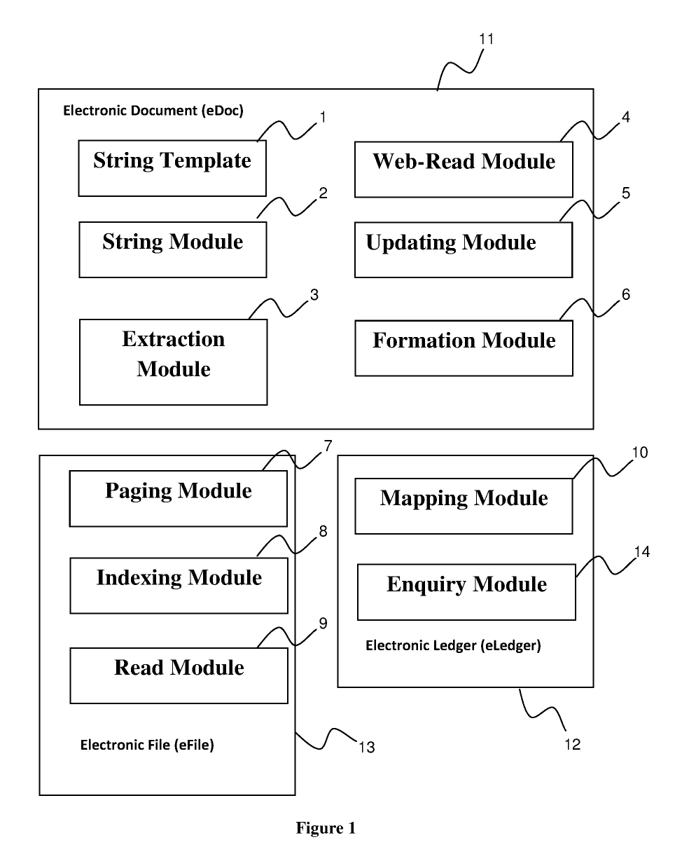

FIG. 1 illustrates overall architecture of the Electronic Document (eDoc) and Electronic File (eFile).

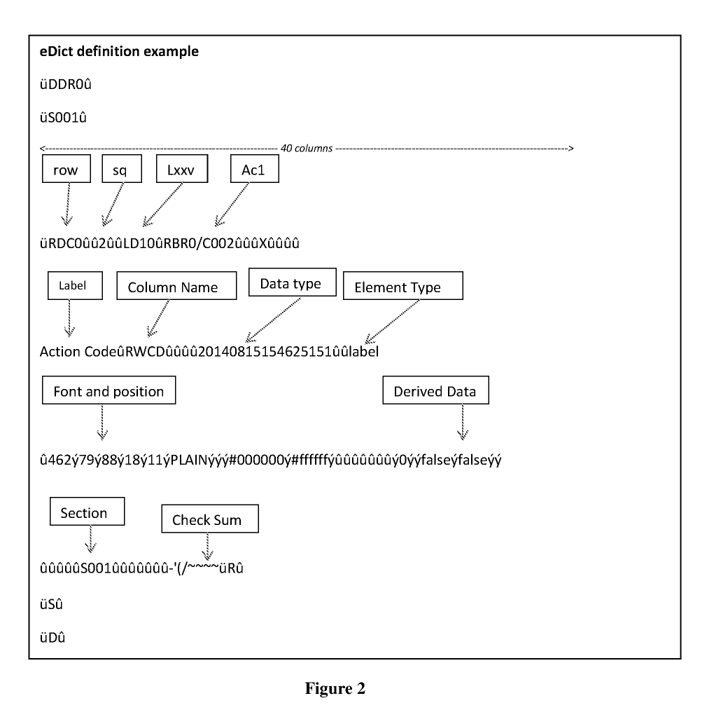

FIG. 2 illustrates an example of Electronic Dictionary (eDict) or metadata is used to describe the attribute/behavior in a string.

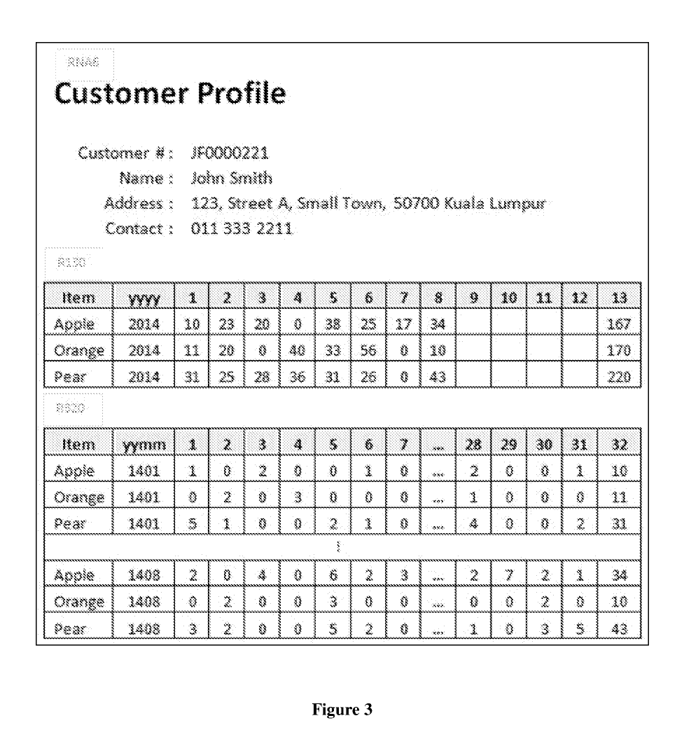

FIG. 3 illustrates an example eLedger containing details of a customer profile and item details.

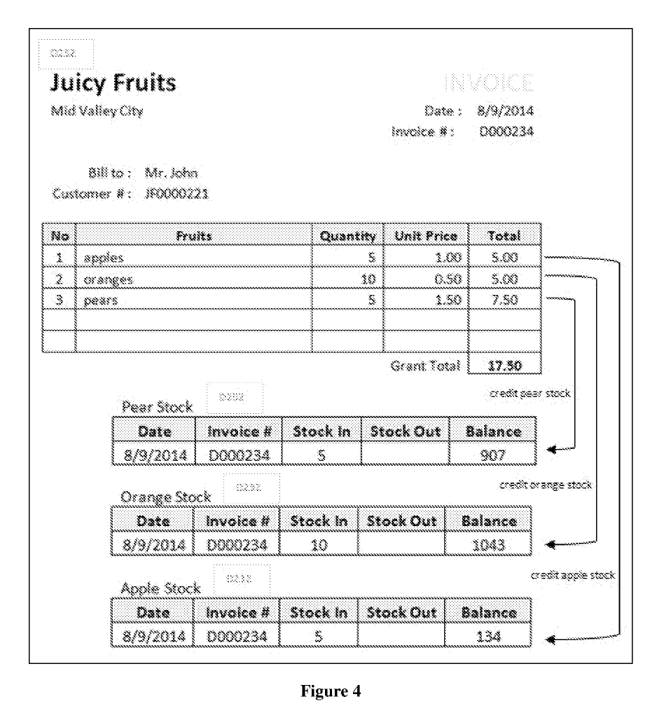

FIG. 4 illustrates an example creation of subDoc based on the example as in FIG. 3.

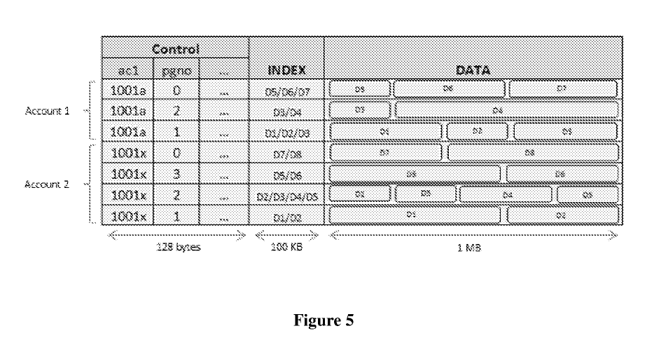

FIG. 5 illustrates an example of how eFiles store in a RDBMS Table.

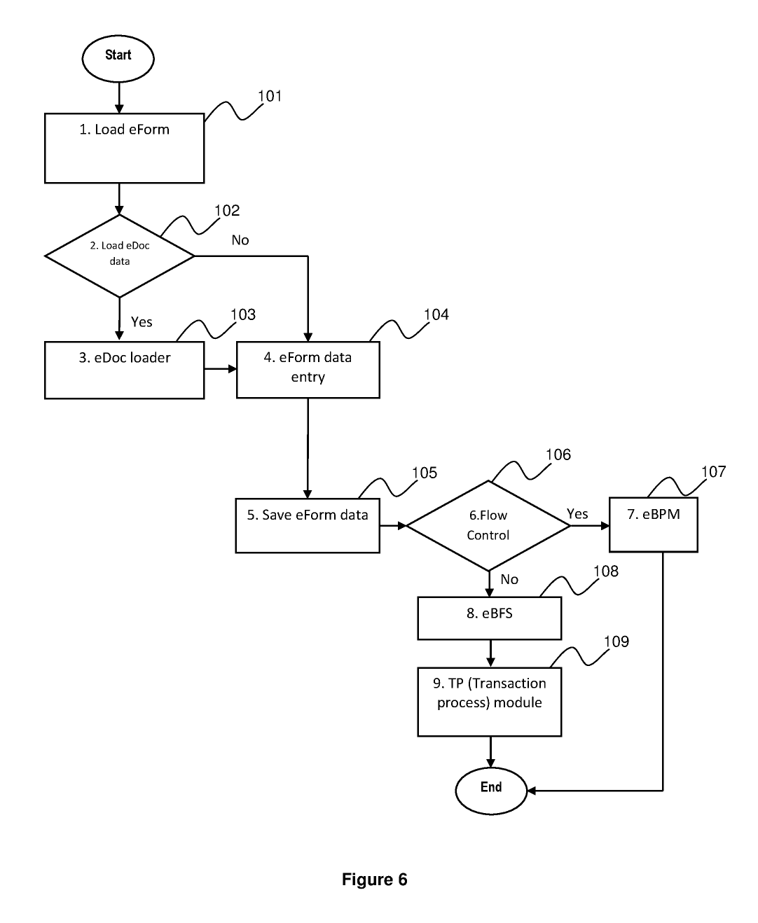

FIG. 6 illustrates a overall flow chart of Web processing module to generate and load Electronic Form (eForm) based on Electronic Document (eDoc).

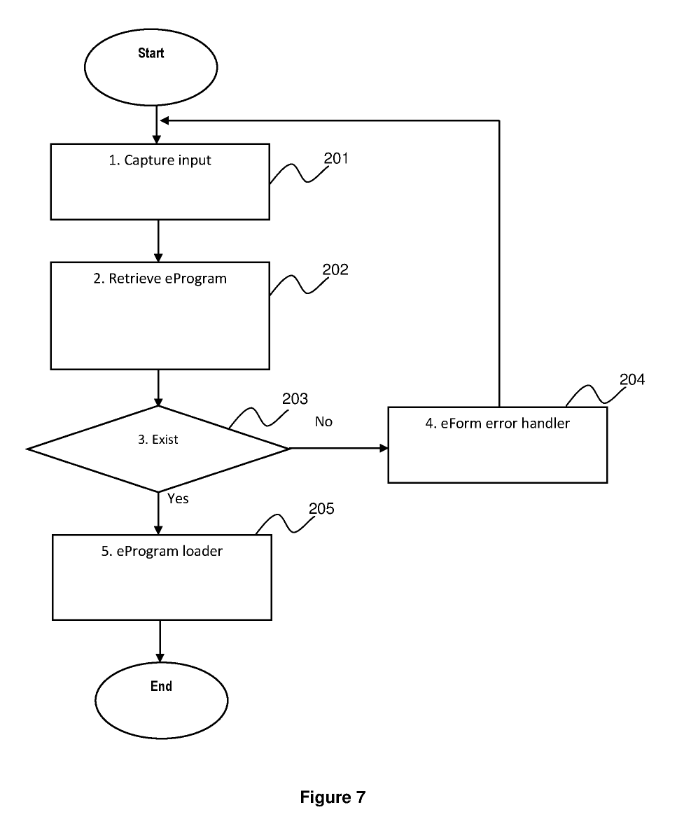

FIG. 7 illustrates a flow chart of Web processing sub-module to retrieve predefined Program (eProgram) in a Program Module from database and load it into Electronic Form (eForm).

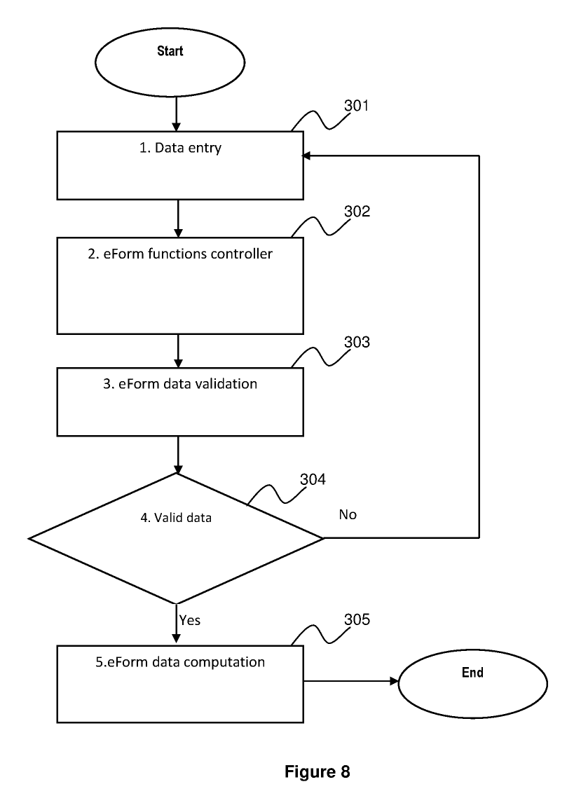

FIG. 8 illustrates a flow chart of Web processing sub-module to perform computation on the Electronic Form (eForm) based on retrieve data entry.

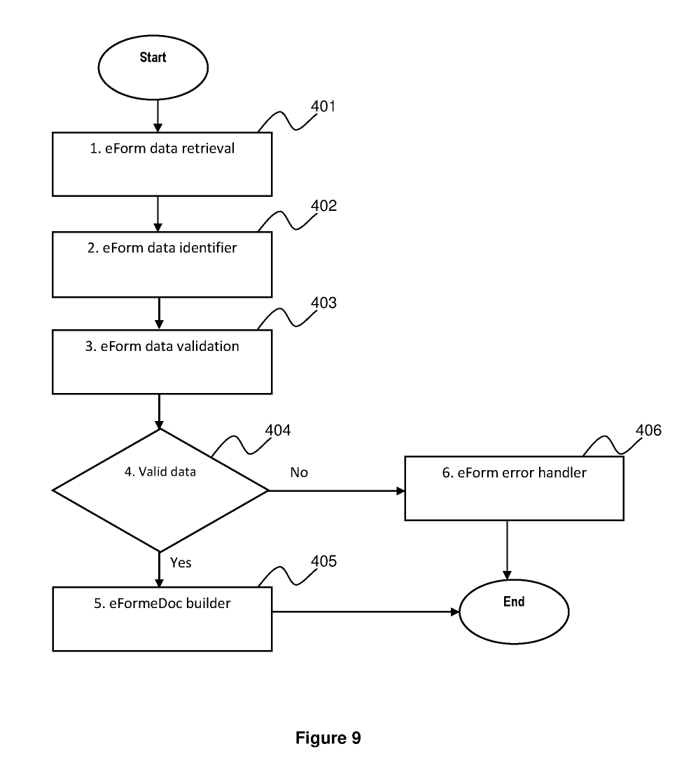

FIG. 9 illustrates a flow chart of Web processing sub-module to build a Electronic Form (eForm) Electronic Document (eDoc) based on predefined validation.

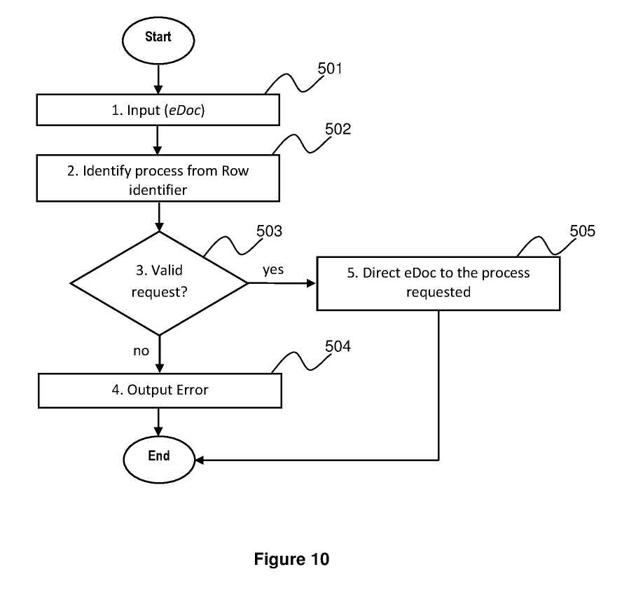

FIG. 10 illustrates a flow chart of Communication Processing module to identify and direct the eDoc to the requested process.

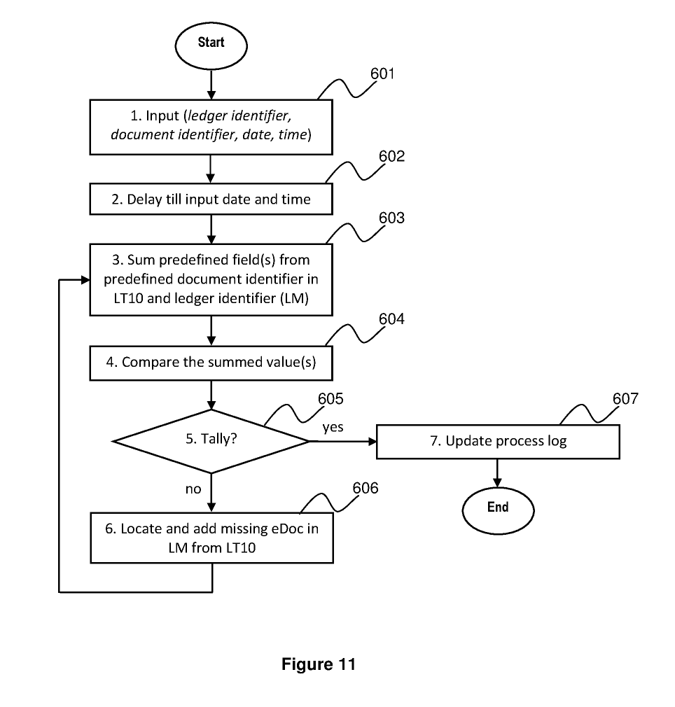

FIG. 11 illustrates a flow chart of a Online Processing Module to validate a total sum of the transactions of Transaction eLedger and Master eLedger.

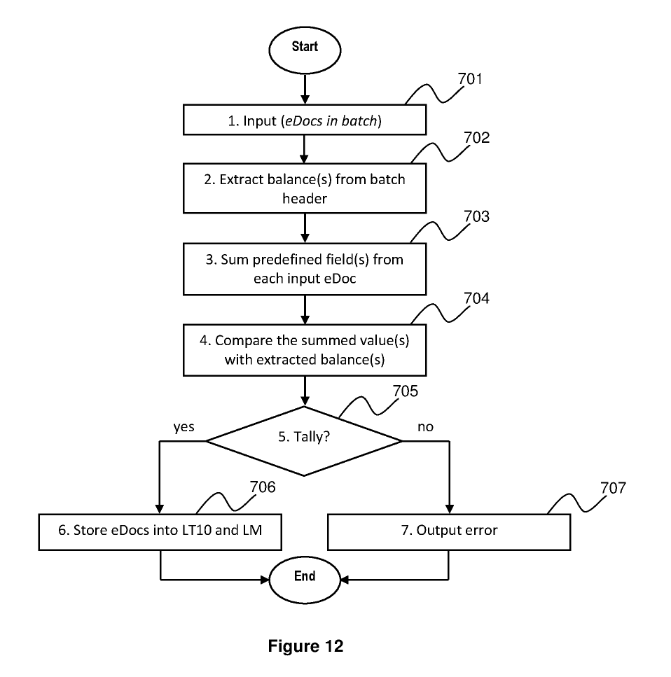

FIG. 12 illustrates a flow chart of a Batch Processing Module to compare the sum balance of each transaction from a batch of eDocs and the total sum with the pre-summed value from the batch header of eDocs.

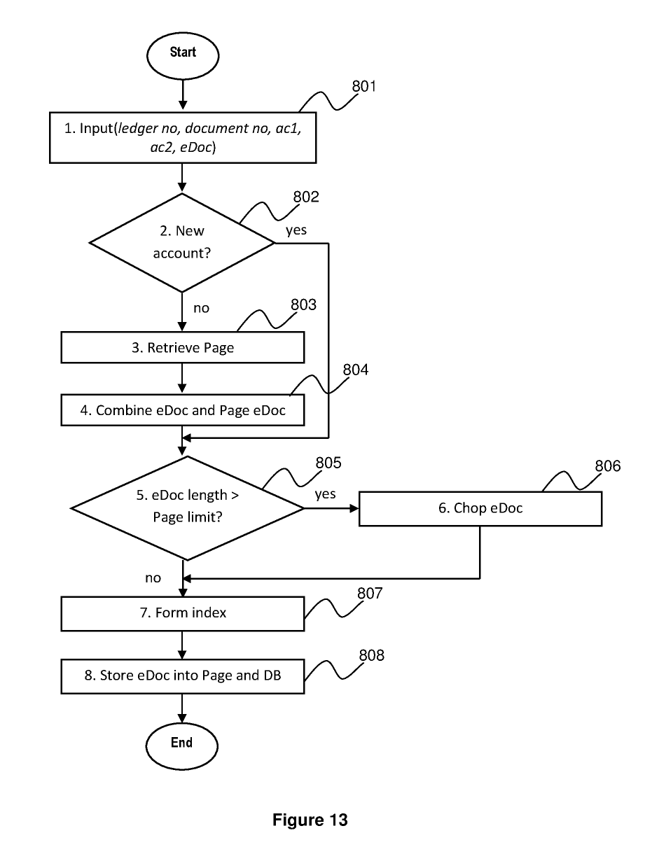

FIG. 13 illustrates a flow chart of a Storage Processing Module for storing transaction (eDoc) into database using the Paging Module.

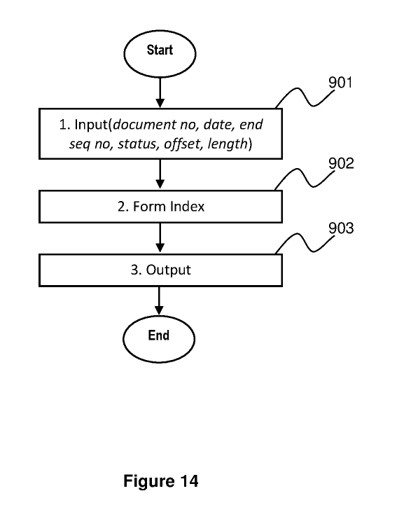

FIG. 14 illustrates a flow chart of a Storage Processing Module for storing transaction (eDoc) into database using the Index Module.

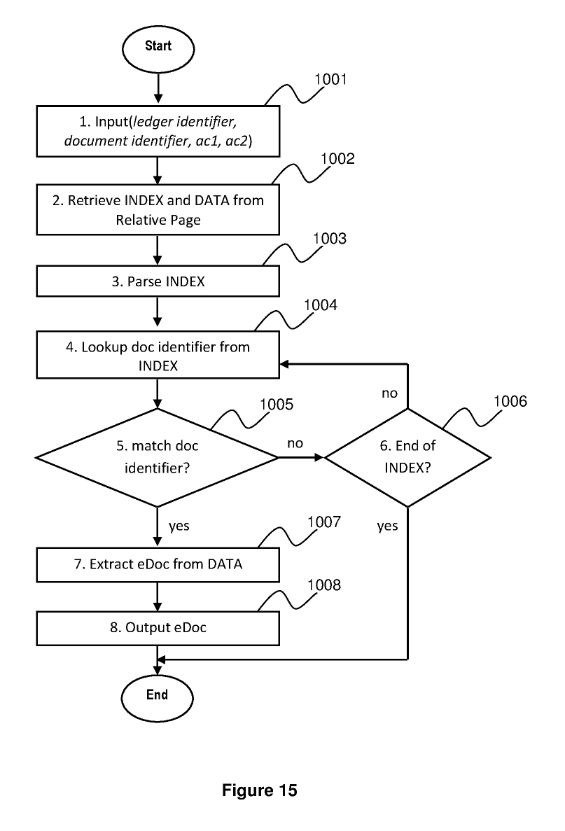

FIG. 15 illustrates a flow chart of a Storage Processing Module for storing transaction (eDoc) into database using the Reading Module.

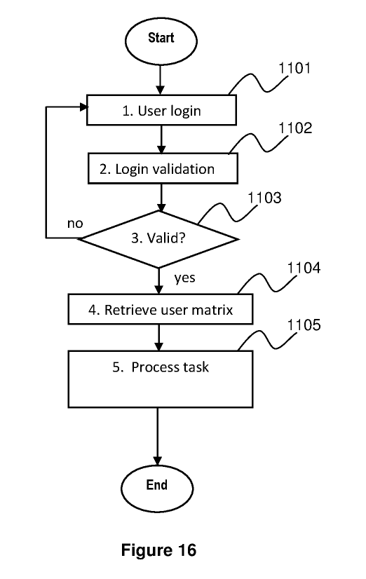

FIG. 16 illustrates a flow chart of a Electronic Business Processing Module (eBPM) to identify and assign at least one task sequences and storing into Electronic Filing (eFiling) system

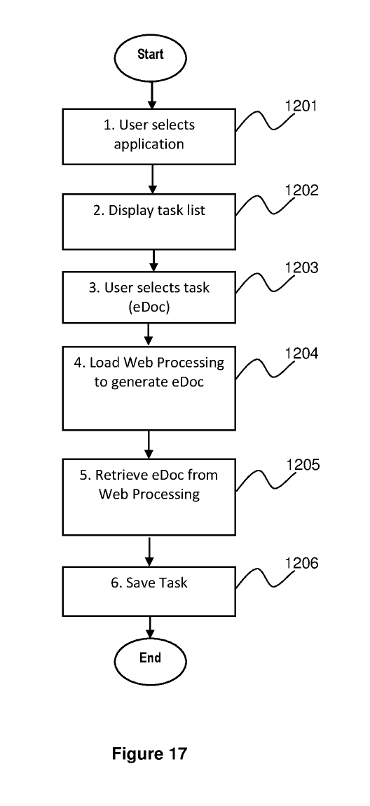

FIG. 17 illustrates a flow chart of a Electronic Business Processing sub-Module (eBPM) to select and save at least one task sequences.

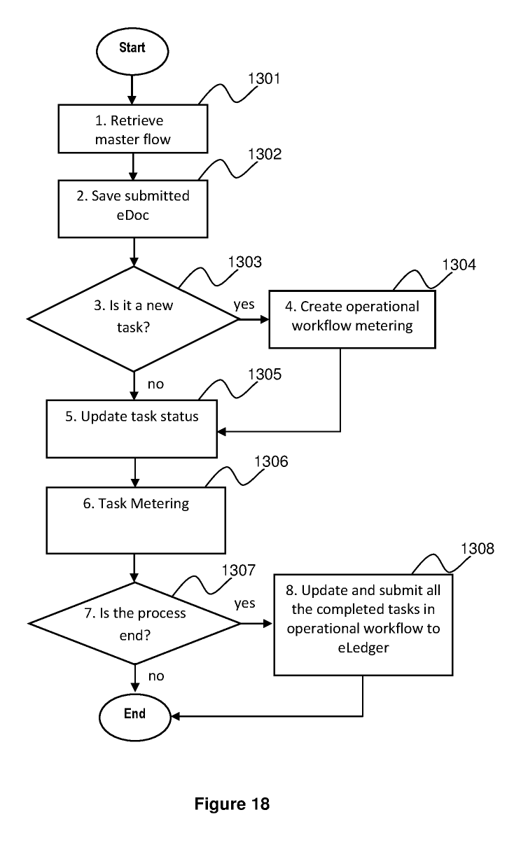

FIG. 18 illustrates a flow chart of a Electronic Business Processing sub-Module (eBPM) to create and update at least one task sequences.

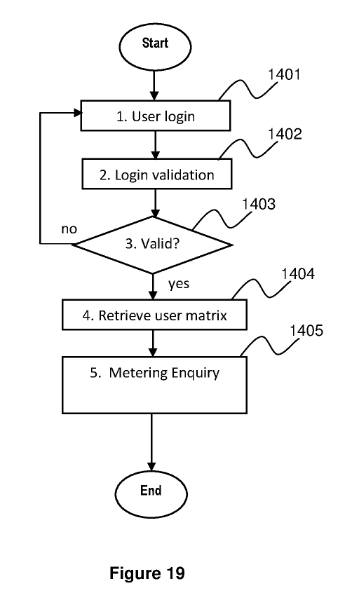

FIG. 19 illustrates a flow chart of a Electronic Business Processing sub-Module (eBPM) to performs metering enquiry based on user validation.

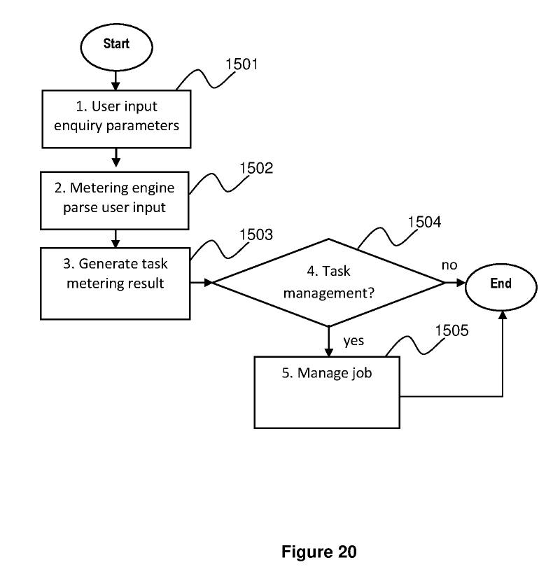

FIG. 20 illustrates a flow chart of a Electronic Business Processing sub-Module (eBPM) to display metering result and task management based on user login detail.

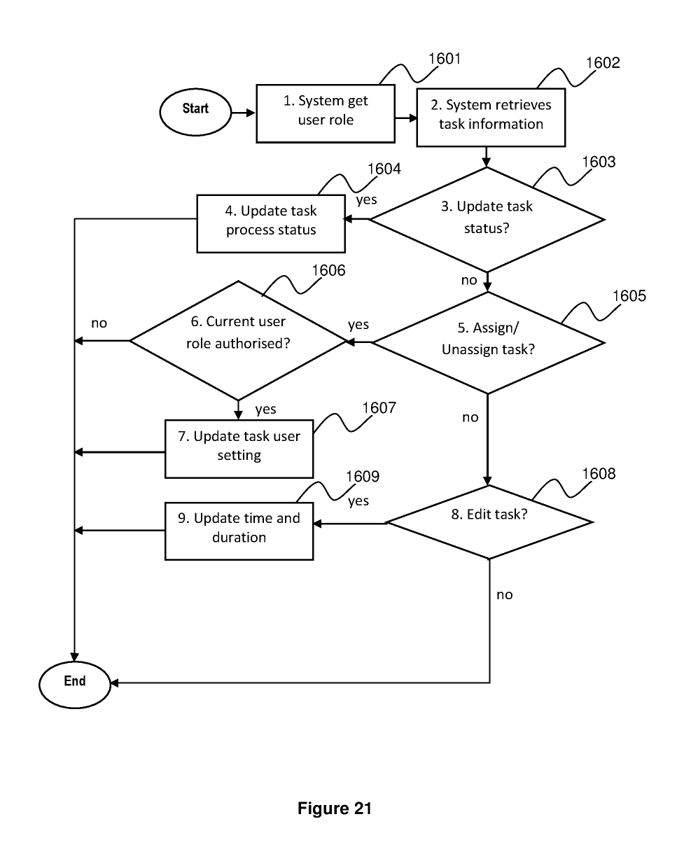

FIG. 21 illustrates a flow chart of a Electronic Business Processing sub-Module (eBPM) to update status and assign task based on retrieved user role.

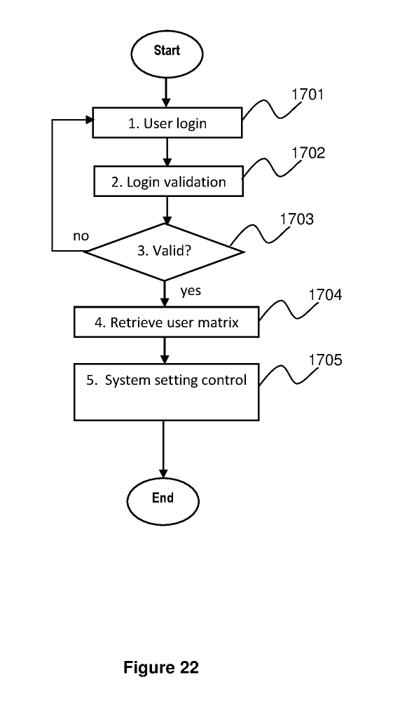

FIG. 22 illustrates a flow chart of a Electronic Business Processing sub-Module (eBPM) to performs system setting control based on user login detail.

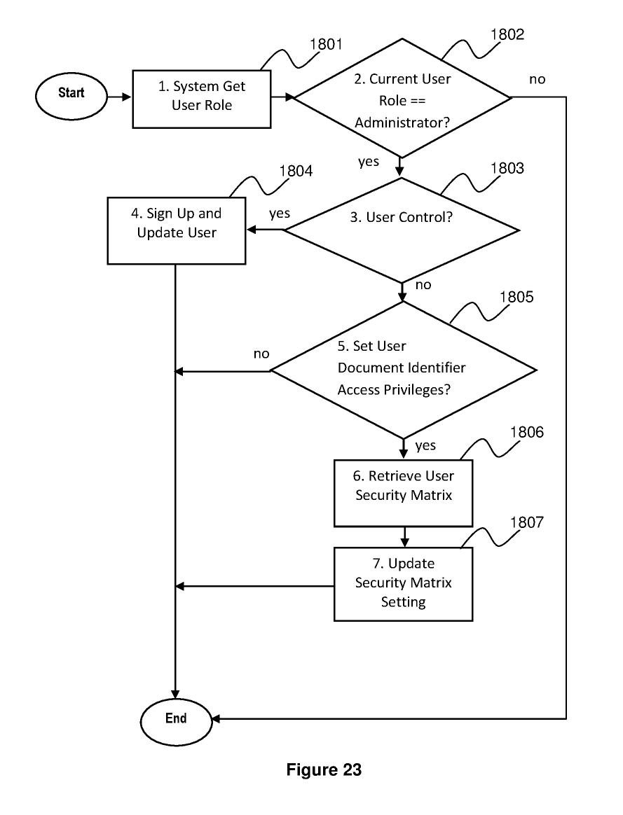

FIG. 23 illustrates a flow chart of a Electronic Business Processing sub-Module (eBPM) to performs system setting control on User Control or Document Identifier Access Privileges.

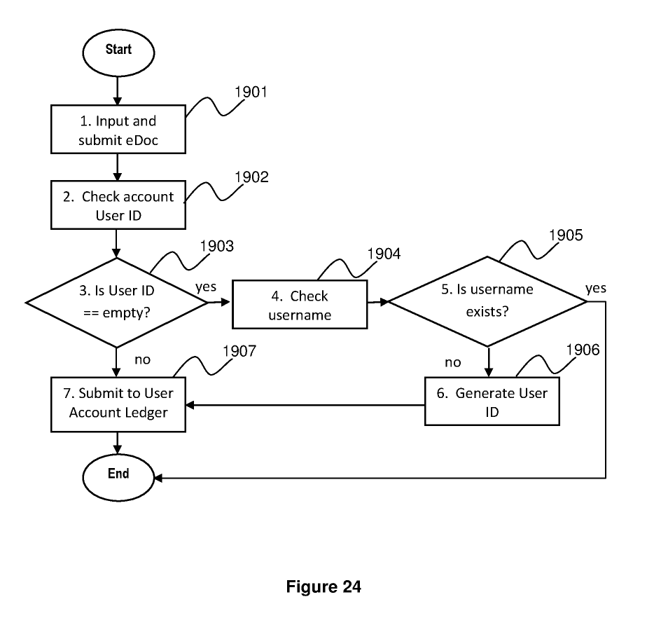

FIG. 24 illustrates a flow chart of a Electronic Business Processing sub-Module (eBPM) to performs Sign Up for new User Account and Edit existing User Account.

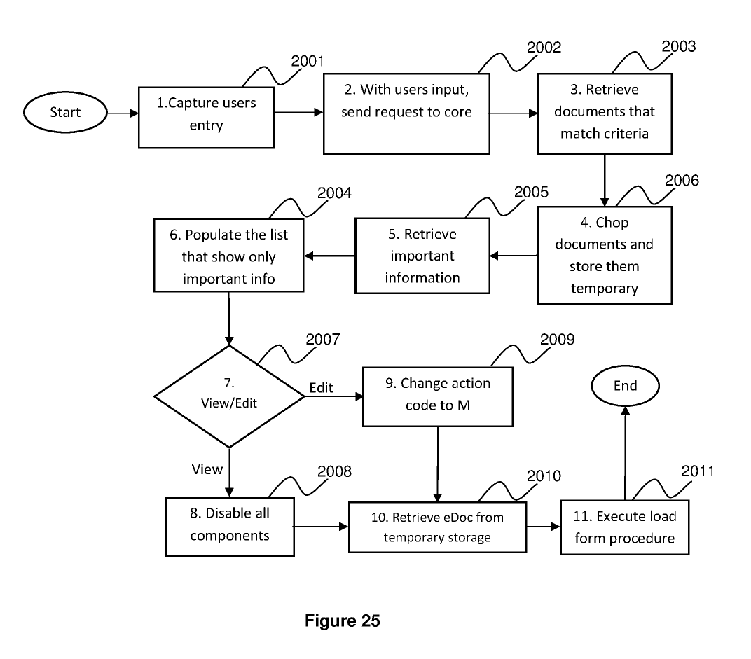

FIG. 25 illustrates a flow chart of a Enquiry Module for retrieving a pluralities of Electronic Document (eDoc) information based on at least one Information having at least one file history display into at least one list form.

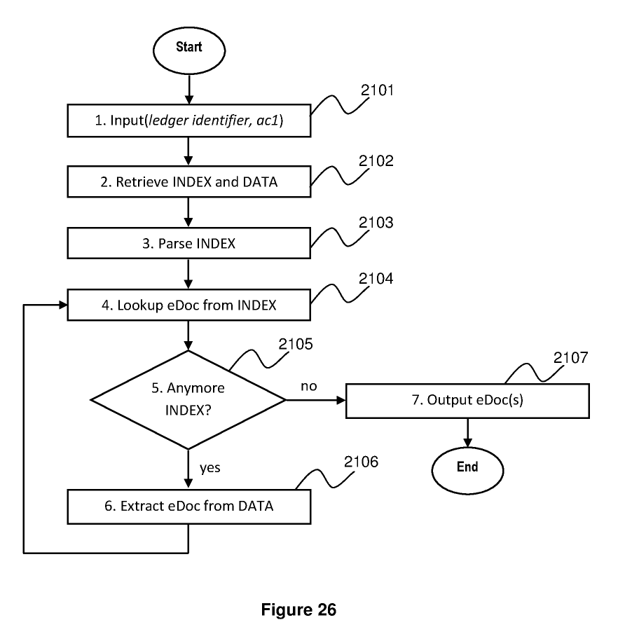

FIG. 26 illustrates a flow chart of a Enquiry Module for processing the Enquiry based on INDEX (indexes) and DATA.

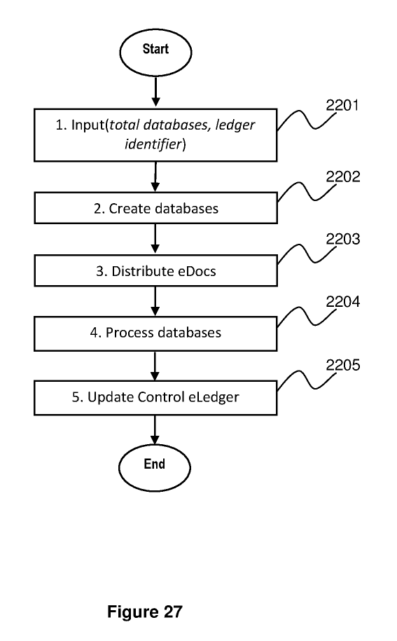

FIG. 27 illustrates a flow chart of a Parallel Processing Module.

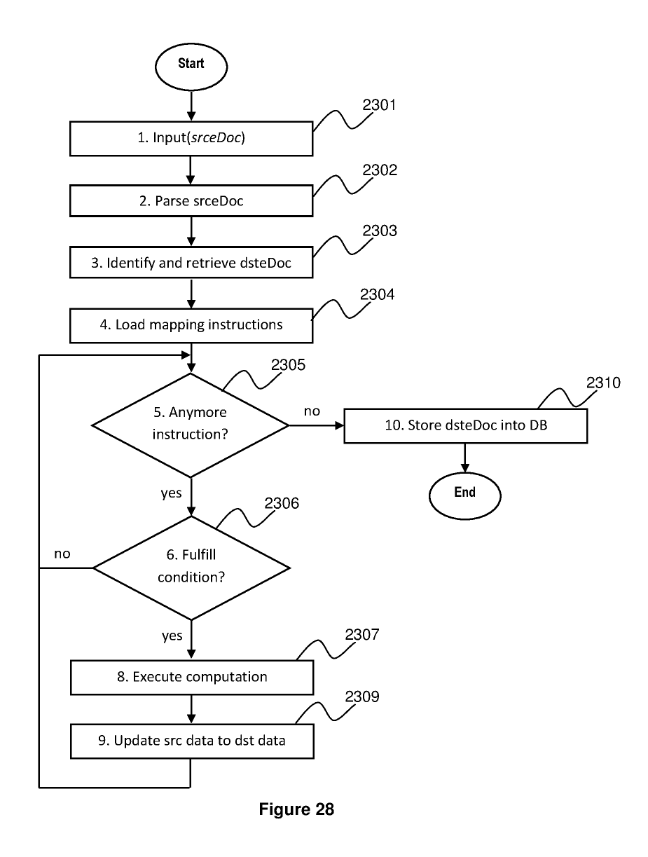

FIG. 28 illustrates a flow chart of a Mapping Processing Module.

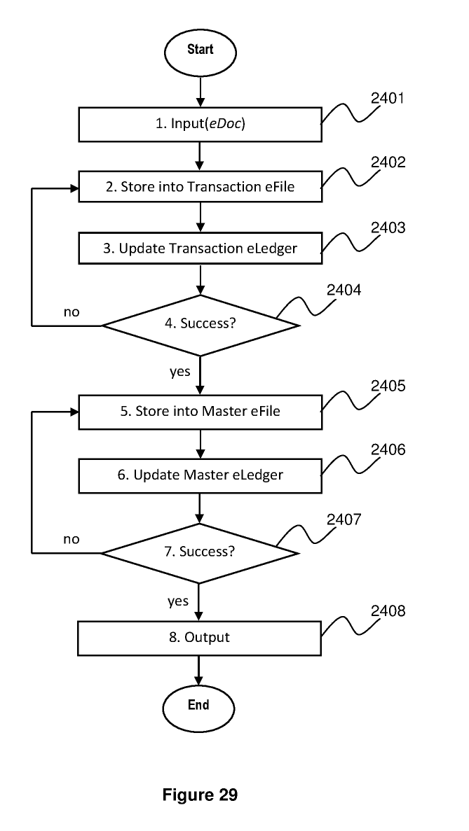

FIG. 29 illustrates a flow chart of a Transaction Processing Module.

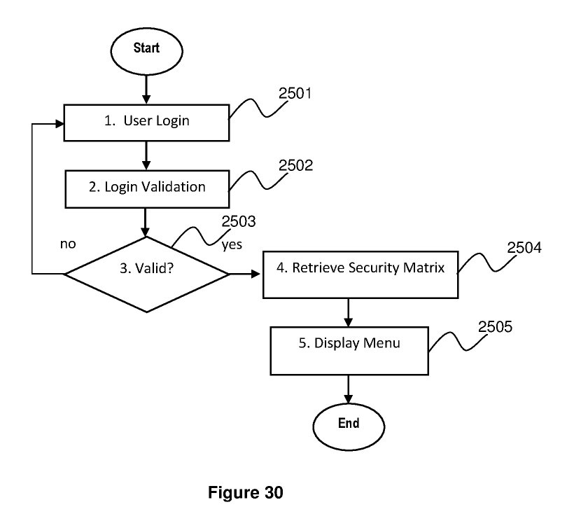

FIG. 30 illustrates flow chart of System Generator Module for login authentication process and menu display.

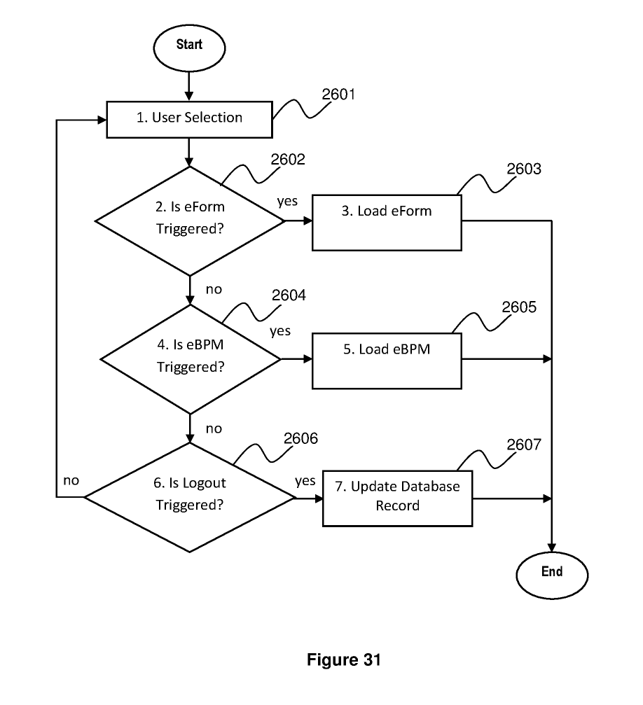

FIG. 31 illustrates flow chart of System Generator Module for user selection process from menu.

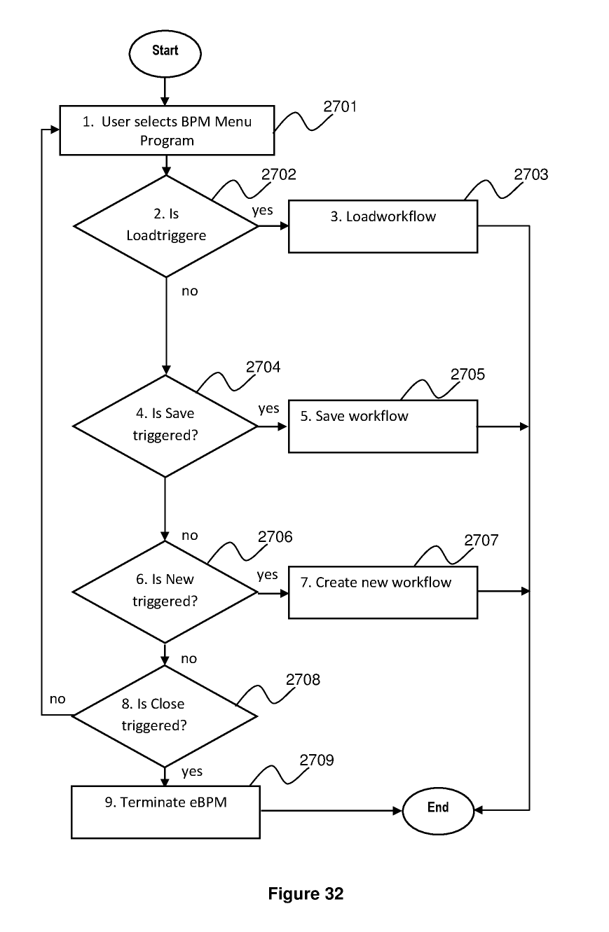

FIG. 32 illustrates flow chart of Electronic Business Processing Module (eBPM) Generator for user selection process from menu.

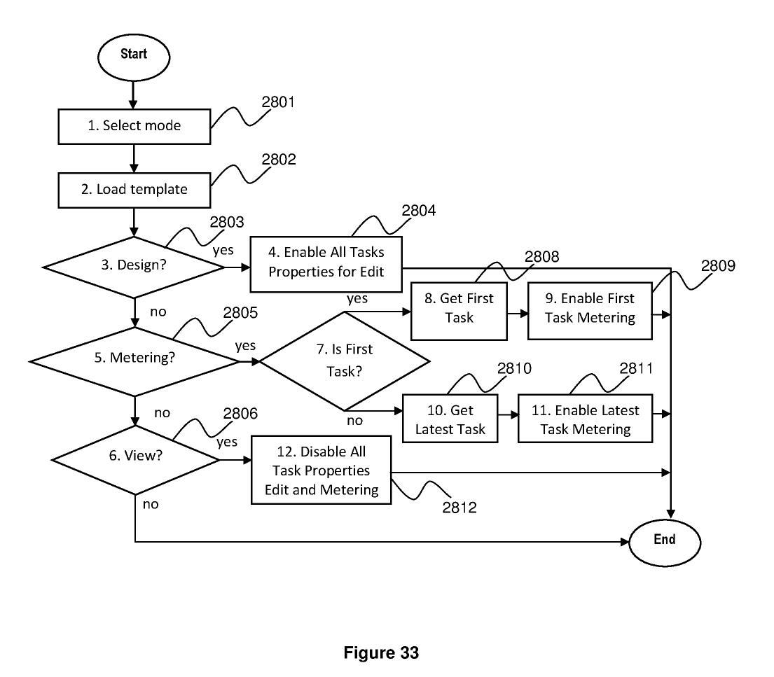

FIG. 33 illustrates flow chart of Electronic Business Processing Module (eBPM) Generator for Design, Metering and View operation modes.

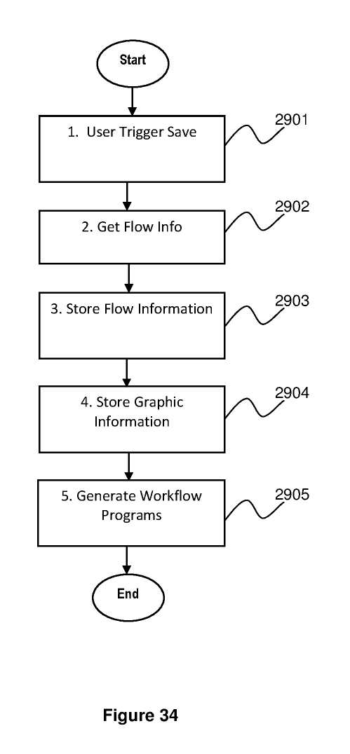

FIG. 34 illustrates flow chart of Electronic Business Processing Module (eBPM) Generator for saving a workflow of Design, Metering and View operation modes.

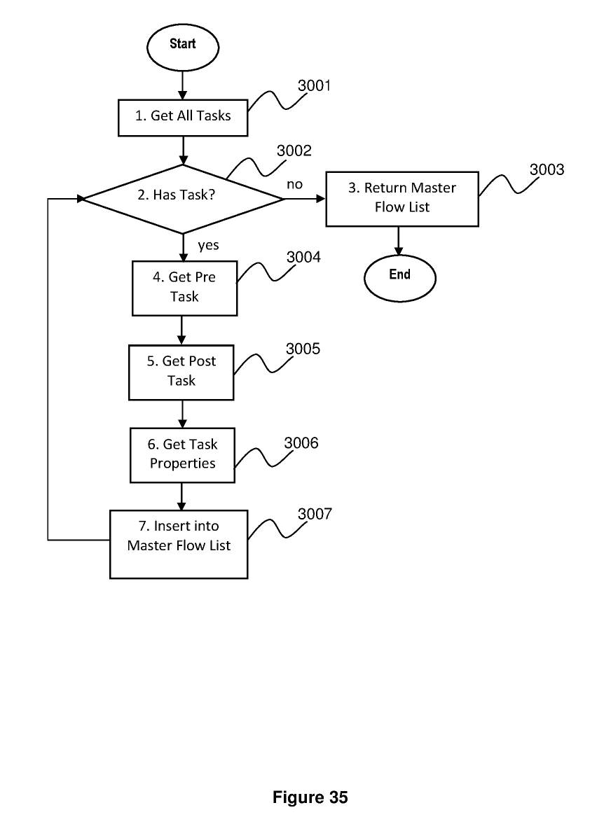

FIG. 35 illustrates flow chart of Electronic Business Processing Module (eBPM) Generator for extracting a workflow of Design, Metering and View operation modes.

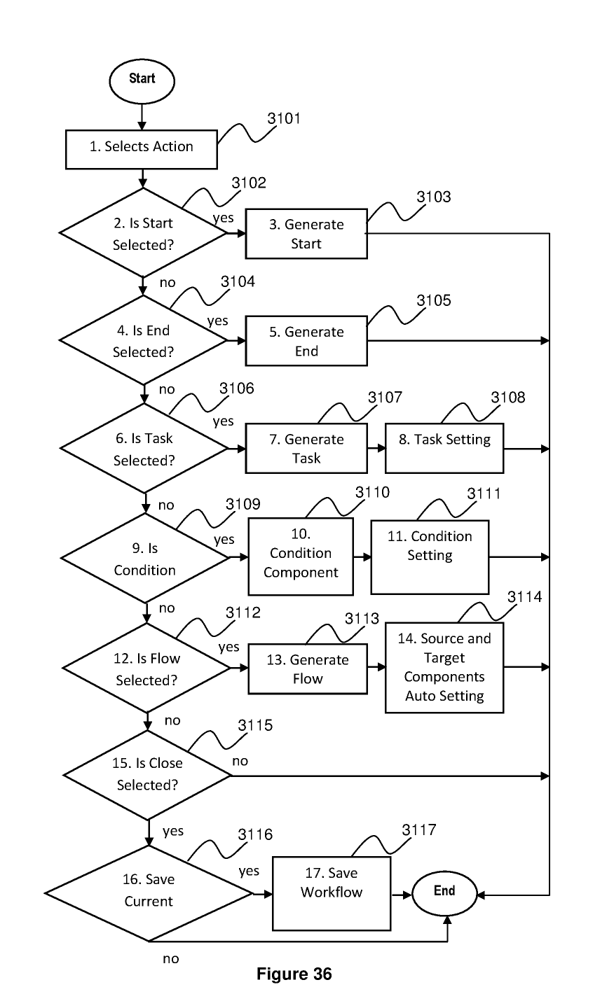

FIG. 36 illustrates flow chart of Electronic Business Processing Module (eBPM) Generator for forming a workflow of Design, Metering and View operation modes.

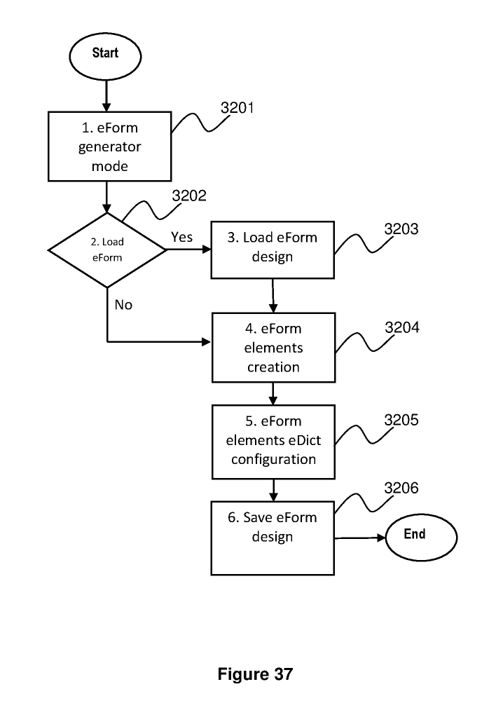

FIG. 37 illustrates flow chart of Electronic Form (eForm) Generator for adding elements based on Electronic Dictionary (eDict) into Electronic Form (eForm).

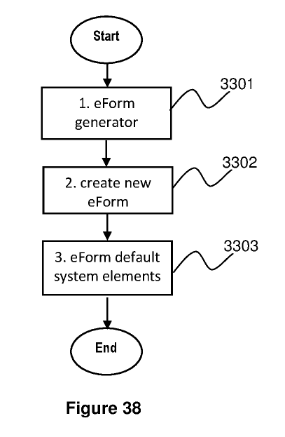

FIG. 38 illustrates flow chart of Electronic Form (eForm) Generator for generating a new Electronic Form (eForm).

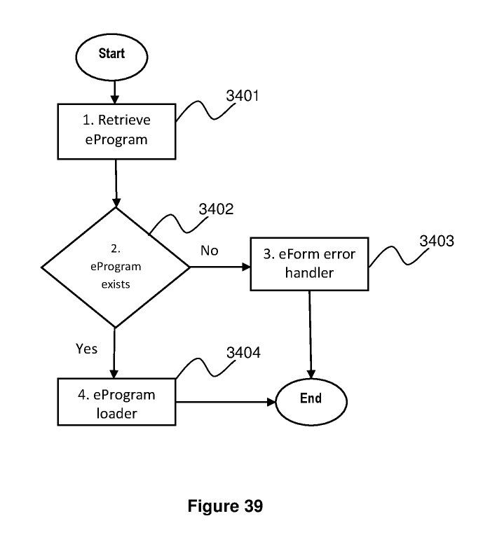

FIG. 39 illustrates flow chart of Electronic Form (eForm) Generator for generating a Electronic Form (eForm) based on predefined program.

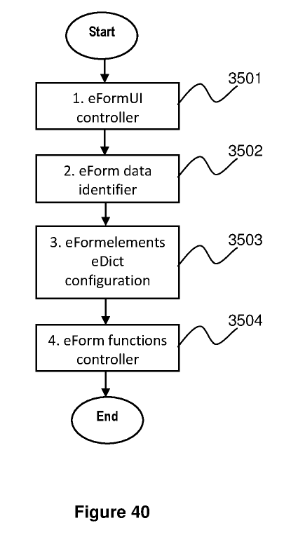

FIG. 40 illustrates flow chart of Electronic Form (eForm) Generator for forming a elements to be added based on Electronic Dictionary (eDict) into Electronic Form (eForm).

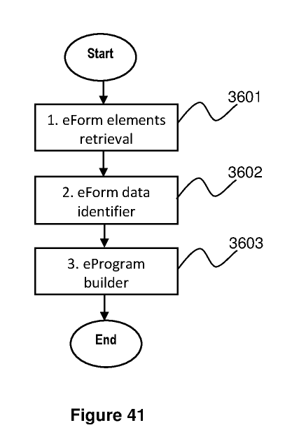

FIG. 41 illustrates flow chart of Electronic Form (eForm) Generator for forming a Electronic Form (eForm).

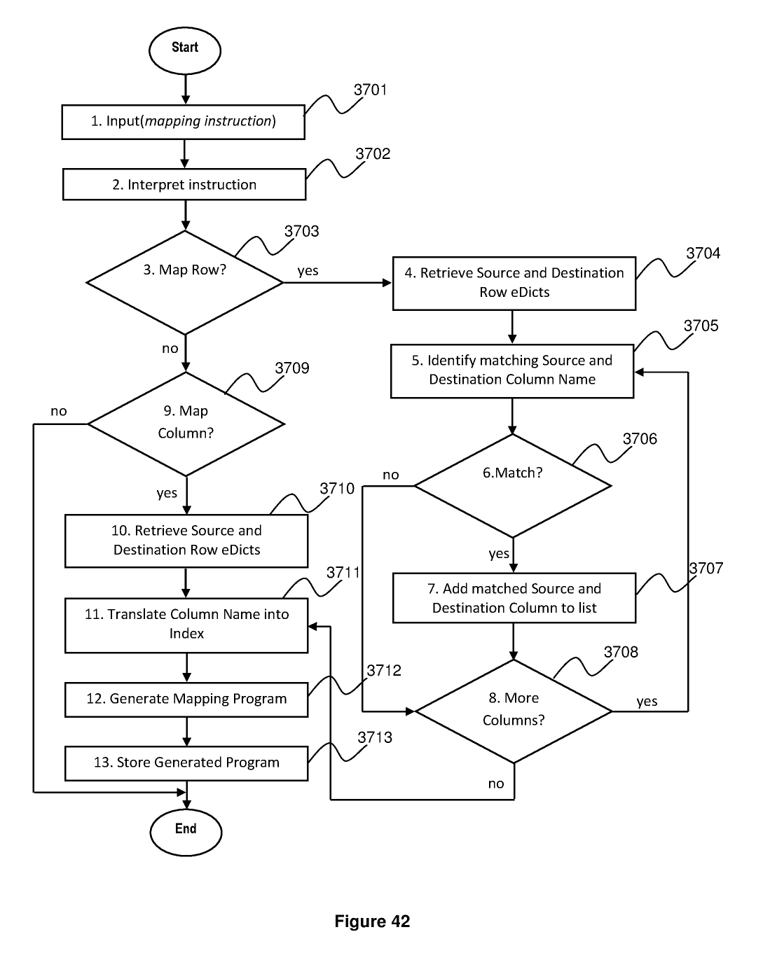

FIG. 42 illustrates flow chart of Mapping Generator for forming a Mapping Program based predefined mapping instructions.

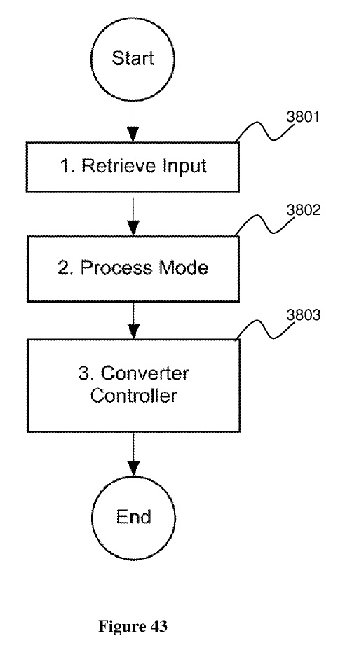

FIG. 43 illustrates overall flow chart of the exchange process.

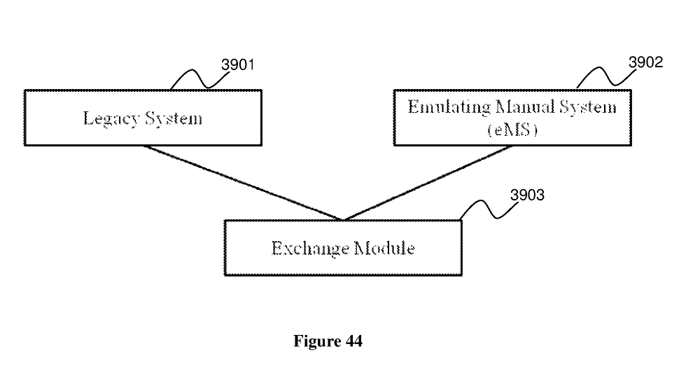

FIG. 44 illustrates a block diagram of the two-systems.

FIG. 43 illustrates overall flow chart of emulating manual filing system using electronic document and electronic the filing.

### DETAILED DESCRIPTION OF THE PREFERRED EMBODIMENTS

The proposed invention relates to a system and method to emulate manual filing system by storing and processing document that operates on Relational Database Management System (RDBMS).

Data is stored in a format called Electronic Document (eDoc), which serves as the display, storage, processing, and transmission format throughout the systems development life cycle, without transformation at any stage. Data can be imported from or exported to any format including PDF, XML, XLS and CSV.

An Electronic File (eFile) stores eDocs (with all data file types) on a database (RDBMS). Filing System predominantly utilizes the database read, write and index functions only. Therefore it can utilize almost all popular RDBMS, and if necessary can handle any customized, in-house database systems.

As illustrated in FIG. 1, the system to emulate manual filing system for storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Page Zero of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Mapping Module (10) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. The Electronic Document (eDoc) are stored as sequential strings of data mapped to a data dictionary, and may include multiple data types in each string (e.g.

image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String

Example of eDoc String-Data Structure: (Store in LxxV)

```
üDxxVû
    üSxxVû
        üRID0ûûûûûûûûûûûûûûûûûûûûûûûüRû
        üRxxVûûû ... ûûûüRû
        ...
        üRxxVûûû ... ûûûüRû
    üSû
    ...
    üSxxVû
    ...
    üSû
üDû
```

Terminators (Separator) Coding Structure

TABLE 1.0
Basic Separator

| Code | Separator | Example |
|---|---|---|
| üDxxVû | Start Document | üDJS4û - start of Job sheet |
| üDû | End Document | üDû |
| üSxxVû | Start Section | üS001û - start of 1^{st} Section |
| üSû | End Section | üSû |
| üRxxVû | Start Row | üRNA1û - start of Name/Address Row |
| | | v1 |
| üRû | End Row | üRû |
| û | Field Separator | ûfield-1û . . . ûfield-n |
| ý | SubField | ý sub field-1 ý . . . ý subfield-n |
| | Separator | |
| ü[ | Open Packet | ü[üDJS1 . . . open packet for subDoc of |
| | | DJS1 |
| ü] | Close Packet | . . . üSûüDûü]close packet for the |
| | | subDoc |

LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RID0) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the u[ . . . u] and stored in a Column. The LDSRC Codes is also representing the GIS of an eDoc String stored. To retrieve the eDoc String, the LDSRC Codes are used to locate them.

Example of eDoc String: (Store in LHR0)

```
üDHR1û
    üS001û
        üRID0ûdxxvû1ûUûLHR0ûLD08003ûûûDHR1ûCûûûûûûûId1302
        EûLeave Applicationû12/12/2013ûûûû,&-.~~~~ûüRû
        üRNA5ûû1ûUûûûûûûûûûûûUploadûûûûûûNurul
        AfizabintilbrahimuLot No. 4 LrgKingland 1, TmnKingland
        Phase 2, 88100 Petagas, KKuMalaysiauNurulAfizabintil
        brahimuDato Sri MikeûSisterû016-8451196ûûIT
        SUPPORTuFizaûûûûûûûûûû8ûSUPPORTûûûûûûûûûû1430996
        7û830430-12-5720ûûû454 101 9729û61692683û830430-12-
        5720û2000û2500û500ûûûûûûcobraangels@gmail.comûûûûûûû
        ûûûûûûûû20Oct08û20Jan09û29/11/2013û28/11/2013ûûûûûûûûû
        ûûûûûûûûûûûûûûûûûûûûûûûPETALING JAYAûûûûûûû014
        3757463ûûûûûûûûûûûJûnior Server
        AdministratorûûûûûûûFemaleûûokûokûokûRecommendedûûûû
        OTHERSû4.0û12ûûûû11.0û09/12/2013û1ûUûCREATIVEûûûû0
        0000036ûProject Loanûûûûû(,\grave{ },)~~~ûüRû
        üR133ûû1ûûûûûûûûûûûûûûûûû2û2û2013ûûûD318ûALûûûûûûû‘
        ’,(~~~~uuRu
        üRRpD1ûû1ûûûûûûûûûûûûûûûûûûûûûûûûûûtesting approve
        10.40ûûûûûûûûûûûûûûûûûûûûûûûûûûûûûûûûûûûûûûûûûûûûûû
        ûûûûûûûû04/12/2013ûûûûûûûûûûûûûûûûûûûûûûûûûûûûûûûûûa
        aaaaaaaûûûûûûûûûûûûûûûûûûûûûûûûûûû111ûûûûûûûûûûûûûû
        ûûûûûûûûûûûûûûûûûûûûûû*&&-~~~~ûüRû
        üR134ûD313û1ûûûûûû1640ûûûûûûûûûûûû1640û2014ûûûû
        PERSONALLOANûû
            ü[
                üDHR1ûüS001ûûRID0ûdxxvû1ûUûLHR0ûLD0800
                3ûûûDHR1ûCûûûûûûûId1302EûLeave
                Applicationû12/12/2013ûûûû,&-.~~~~ûüRû
                üRR134ûD313û1ûûûûûû1640ûûûûûûûûûûûû1640
                û2014ûûûûPERSONALLOANûûûûûûû(‘−
                +~~~~ûüRûüSûüDû
            ü]
        ûûûûû(‘−+~~~~ûüRû
    üSû
üDû
```

eDict

As illustrated in FIG. 2, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation. The table 3.0, 4.0 and 5.0 shows an example of metadata or library predefined for Ledger, Document and Rowtype.

Ledger eDict—Definition

TABLE 3.0
Dictionary

| # | Name | Function | Length | Descrition |
|---|---|---|---|---|
| 1 | row | data | 4 | RDL0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Ledger (LXXV) |
| 7 | ac2 | data | 16 | |
| 8 | proj | data | 4 | Project |
| 9 | datatyp | data | 1 | |
| 10 | usg | data | 1 | |
| 11 | opt | data | 1 | |
| 12 | subfield | data | 4 | |
| 13 | nm1 | data | 32 | Ledger name |
| 14 | nm2 | data | 32 | Update method (FIFO/LIFO/U/O) |
| 15 | le | data | 2 | Max document |
| 16 | de | data | 1 | |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Document eDict—Definition

TABLE 4.0
Dictionary

| # | Name | Function | Length | Description |
|---|---|---|---|---|
| 1 | row | data | 4 | RDD0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Doc (DXXV) |
| 7 | ac2 | data | 16 | |
| 8 | proj | data | 4 | Project |
| 9 | datatyp | data | 1 | File type (Excel/Email/bin/eDoc) |
| 10 | usg | data | 1 | |
| 11 | opt | data | 1 | |
| 12 | subfield | data | 4 | |
| 13 | nm1 | data | 32 | Document name |
| 14 | nm2 | data | 32 | |
| 15 | le | data | 2 | Size of Doc |
| 16 | de | data | 1 | Version |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Rowtype eDict—Definition

TABLE 5.0
Dictionary

| # | Name | Function | Length | Description |
|---|---|---|---|---|
| 1 | row | data | 4 | RDC0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | RowCol (RxCx) |
| 7 | ac2 | data | 16 | |
| 8 | proj | data | 4 | Project |
| 9 | datatyp | data | 1 | Data (9/A/X/B/D/T) |
| 10 | usg | data | 1 | Usage (C/Blank) |
| 11 | opt | data | 1 | Optional |
| 12 | subfield | data | 4 | Subfield |
| 13 | nm1 | data | 32 | Label |
| 14 | nm2 | data | 32 | Name of column |
| 15 | le | data | 2 | Max Length |
| 16 | de | data | 1 | Decimal (2 dec) |
| 17 | def | data | 16 | Default |
| 18 | hid | data | 10 | HTML ID |
| 19 | htag | data | 4 | HTML Type |
| 20 | htype | display | 4 | # of elements |
| 21 | hstyle | display | 255 | Font, x, y, etc |
| 22 | lig | data | 255 | URL |
| 23 | dup | entry | 1 | Duplicate |
| 24 | msk | display | 200 | Mask |
| 25 | cond | compute | 255 | Condition |
| 26 | comp | compute | 255 | Computation |
| 27 | next | compute | 4 | Tab index |
| 28 | der | data | — | Derived Data |
| 29 | mnle | validate | 2 | Minimum length |
| 30 | mxv | validate | 14 | Maximum value |
| 31 | mnv | validate | | Minimum value |
| 32 | res1 | reserved | | |
| 33 | res2 | data | 4 | Section |
| 34 | res3 | reserved | | |
| 35 | res4 | reserved | | |
| 36 | res5 | reserved | | |
| 37 | bal | data | — | |
| 38 | size | data | — | Size of this row |
| 39 | secu | data | 8 | Security |
| 40 | cksum | data | 8 | Checksum |

Example of eDict Structure

üDDR0û
üS001û
<------------- 40 columns in horizontal representation --------------------->
üRDC0û doc û sq û st û lg û ac1 û ac2 û proj û datatyp û ûsg û opt û
sûbfield û nm1 û nm2 û le û de û def û hid û htag û htype û hstyle û
lig û dûp û msk û cond û comp û next û der û mnle û mxv û mnv û
res1 û res2 û res3 û res4 û res5 û bal û size û secûû cksûmüRû
üSû
üDû

eLedger

Electronic Ledger (eLedger) is where summaries or derivatives of eFile that is kept in variable length or fixed length format thus allowing for greater flexibility and fast retrieval. The Information in eLedger can be deleted and modified. Each eFile can have multiple eLedgers if required (for speedy reporting purposes). The update method of each eDoc to the eLedger is predefined in eLedger dictionary. The eLedger can contain n copies of eDoc that arrange in FIFO or LIFO manner; or new eDoc can override the exiting eDoc in the eLedger; or the update only manipulate data from certain column(s) in eDoc with the predefine column(s) in eLedger. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes-Oxley Act of 2002). The system may further include Reverse Processing where a new eLedger can be generated or regenerated from eFile based on new configuration or updated configuration.

As illustrated in FIG. 3, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

Rowtype Header & Footer

TABLE 6.0

| sq | name | description |
|---|---|---|
| 1 | RxxV | rowtype |
| 2 | RWCD | row code |
| 3 | RWSQ | sequence |
| 4 | RWST | status |
| 5 | RWLG | ledger |
| 6 | RWA1 | account 1 |
| 7 | RWA2 | account 2 |
| 8 | RWCO | company & department |
| . . . | . . . | |
| n + 1 | RWBA | balance |
| n + 2 | RWSZ | size |
| n + 3 | RWSE | security |
| n + 4 | RWCS | checksum |

All Rowtype contains a Header with 8 columns and a Footer with 4 columns as shown on the Table 6 above. The row code (RWCD) of the Rowtype Header indicates its uniqueness among other same Rowtypes that appear within a Section and ledger (RWLG), account 1 (RWA1), account 2 (RWA2) and company & department (RWCO) indicates the location of the Rowtype in the database. The security (RWSE) of the Rowtype Footer is used to ensure that the right user(s) can access this row and the checksum (RWCS) is to ensures the data within the row is not corrupted.

Subsequent Documents (SubDoc)

As illustrated in FIG. 4, the creation of Subsequent Documents (subDoc), where the system splits a Doc so that it can be debited/credited to relevant account, each subDoc is appended as a string one after another. The Main Doc and subDoc(s) will have the same document identifier. For example, an invoice with document identifier, D232 may have a subDoc to debit customer account and subDoc to credit Apple, Orange and Pear Stock. (Referring to the example in FIG. 2).

Reserve and Commit

It's a process where a set of predefined requirements have to be adhered before any updating can take place. For example in an invoice, the requirements will be the customer must have sufficient credit to be debited from the account and there must be sufficient stock to be stocked out before the process is committed.

Header+Index+Data

As illustrated in FIG. 5, the eFiles are stored in a RDBMS table, where the table comprises of Control, Index and Data. The Control section contains key and details about the Page. The Index is used to locate the location of each eDoc in a Page, where the Indexing are done in Horizontal manner to create sub-filing system within a filing system. The Data is where the eFile is stored.

Example of Index for Account 1, Relative Page is as below: DHR0:20140828: 5: U: 0: 122/DHR0:20140828: 6: U: 122: 250/DHR0:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
Ig—ledger identifier
ac1—account 2
lpgn—last page no
ssq—start document sequence no
sin—start Page line no
esq—end document sequence no
eln—end Page line no
date—last updated date
st—the status of the eFile such as deleted
co—company and department
bal—balance of all eDocs

Processing Module

Web Processing System

Web processing system interprets program in at least one Program Module and load a Electronic Form (eForm) to capture data entry, a form with set of instructions and data fields that pre-created and defined in the Program Module, and also displaying any requested Electronic Document (eDoc) that compatible with loading form. While user enters data into the Electronic Form (eForm), validation occurs on field pre-defined in Electronic Dictionary (eDict), which will alert the user and guide the user entering the data, and perform eForm LLG (library of pre-defined program to assist user on data entry) based on user's trigger.

On user's trigger or input, the eForm will captures and save data from form into eDoc, and pass to Electronic Business Processing Module (eBPM) for flow control, mapping and storing into Electronic Filing (eFiling) system.

Electronic Browsing Filing System (eBFS) is a client storage system. The main objective is to achieve faster eDoc retrieval, and able to remain functional even the system has no access to Internet.

The eForm provides an electronic form with tools to capture new insert data, manipulate form, and also eDoc formation. The system able to read and load predefined Program (eProgram) from database into eForm. Furthermore, it able to save data, form into eDoc and store into database.

It provides tools, for example eForm functions that have more variety options to access and manipulate eDoc and eForm. For example, real-time loading or saving eForm, fetching eDocs from database and populating the eDocs into table, etc. The Data validation will ensure data inserted is adhered to the predetermine formats.

Communication Processing System

From the Row Identifier, the type of process is identified and the Electronic Document (eDoc) will be directed to the requested process. The Electronic Document (eDoc) is directed to any processed without a single data transformation.

Online Processing

All transactions are stored into database in real-time. By the end of each business day, the scheduled Sarbanes-Oxley (SOX) compliance process will kick in to ensure that the total sum of the transactions for the day stored in Transaction Electronic Ledger (eLedger) is equals to the sum of the transactions for the day stored in Master eLedger. If there is a missing transaction in the Master eLedger, the missing transaction will be recovered from the Transaction eLedger.

Batch Processing

All transactions will be verified through the Sarbanes-Oxley (SOX) compliance process before storing into database. The process will sum the balance of each transaction from the batch and compare the total sum with the pre-summed value from the batch header. If the total sum and pre-summed value is tally, the entire batch of transactions will be stored into database. If otherwise, an error message will be prompted.

Storage Processing

The transaction (eDoc) is stored into database through Paging Module and Index Module. Each eDoc will be appended to the Electronic File (eFile) and if the eFile length is longer than the Page Limit, the excess of the eFile will be stored into next Page(s). The Index will be created for each eDoc that has been appended to eFile. The eDoc Read Module will rely on the Index created to locate the eDoc required.

BPM Processing

Electronic Business Processing Module (eBPM) will govern the process/system flow of the IT system/software. From the master system flow information, System will identify the task sequences. If current task is the first/new task, System will create an operation workflow ID. For non-first task, System will update the existing operational workflow status. Then, System will process the next task of the operational workflow for user execution. It supports metering features and enable user to know the status and progress of any task in every single processes. User will select the application to launch. System will load tasks to be executed by user. System will check user role before execute the task. When user submits task, system will retrieve the master system flow information from Ledger Identifier and Document Identifier. Then, the submitted task which is eDoc will be stored in temporary memory.

The System able to perform Electronic Business Processing Module (eBPM) process by reusing the same document. The document information is stored in eDoc. During system operation, same document(s) are circulating for execution according system flow in Business Processing Module (BPM).

The Electronic Business Processing Module (eBPM) task is generated as program and stored in eDoc.

User security matrix is created to enable user to read, write, update and delete for every Electronic Business Processing Module (eBPM) task. Every task in Electronic Business Processing Module (eBPM) process is governed by user security matrix.

The eBPM task assignment details are stored in eDoc. Since BPM task is stored in eDoc, User can assign/unassign task by circulate the eDoc. In eBPM task management, user can create, execute, update and delete task.

Every stage in eBPM process is metered and stored in eDoc. This enable fast eBPM Metering enquiry because user can enquiry every task metering information directly from eDoc, without required any data manipulation to display task metering information to user. The eBPM Metering enable user perform enquiry by account and application level. User can enquiry task metering information by enter account or application information.

Enquiry Processing

By virtue of eDocs are stored in the structure manner (Ledger-Document-Section-Row-Column coding structure), the eDocs can be retrieved in a fast manner through the one and only one Enquiry Processing. From the user input, ledger identifier and account 1, all the related eDoc(s) will be retrieved from database using the List and Zoom Module. User can zoom into each eDoc by clicking the eDoc from the list.

Parallel Processing

The nature of Account-Centric Storage System has enabled the easy distribution of each account to different database at different location. For high speed processing, each database can have dedicated computing resources to process the eDocs that belong to each account.

Each account can be distributed to either 10, 100 or 1000 databases based-on the last, last 2 or last 3 digit(s) of the account number. The parallel processing will process all databases concurrently. By the end of the process, the result from each process will be updated to the Control Ledger to form the final summary.

Mapping Processing

The input data is updated into the database through the predefined Mapping Instruction(s). Each Mapping Instruction will indicate either the update is at document, row or column level. At the column level, the Mapping Instruction might contain condition validation and/or computation before the data is being updated into the database.

ACID (Atomicity, Consistency, Isolation, Durability) Processing is a process that guarantees that transactions are processed reliably before updating to the database. The ACID Processing will be applied during the Mapping Processing whenever it's required. For example, a transfer of funds from one bank account to another, even involving multiple changes such as debiting one account and crediting another, is a single transaction.

Transaction Processing

The Transaction Processing will ensure that any eDocs that are to be stored into the database is Sarbanes-Oxley (SOX) compliance. This is achieved by making sure that the status of each storing and updating process is reported back to Transaction Processing; for this case, eDoc sequence number is used. The process is considered complete when the storing and updating at Transaction eFile and eLedger and Master eFile and eLedger are executed successfully.

System Generator

The System Generator Module is a IT system/software generator used for software generator. This is used by IT or non-IT professional to create a software or IT system. Applicator is named as user of the System Generator Module. Applicator transform the manual system to IT system through System Generator Module.

The Electronic Business Processing Module (eBPM) Generator is an intelligent graphical tools used by applicator to create a system flow diagram and system flow program. When applicator created and saved a system flow diagram, Electronic Business Processing Module (eBPM) Generator will generate task in system flow into program and store into Electronic Document (eDoc).

The Electronic Business Processing Module (eBPM) Generator also allows users to print, view, design and edit a system flow. The changes of IT system/software system flow can be done immediately through Electronic Business Processing Module (eBPM) Generator. Applicator only needs to edit the graphical system flow diagram to modify the system flow program. Electronic Business Processing Module (eBPM) Generator able to capture and update the changes to the system flow program automatically. Electronic Form (eForm), one of the module in the System Generator Module, main objective is to generate electronic form to capture user inputs, and store into Electronic Filing System (eFiling) for further process.

It is very common for users to captures inputs online or offline with electronic form, but making Electronic Form (eForm) so unique and different are, not only Electronic Form (eForm) can generate electronic form, it also allow users to create a new Electronic Form (eForm) within one man day, even users with the least training and knowledge on System Generator Module.

Users can also include Electronic Form (eForm) functions for (LLG—a library of Electronic Form (eForm) pre-created program) some special actions, for example manipulating another element in Electronic Form (eForm), fetch data from Electronic Filing System (eFiling) etc. This allows Electronic Form (eForm) to also perform as system application with complicated actions. Within Electronic Form (eForm) design mode, users can also setup Electronic Dictionary (eDict) for each element, thus granting more control over Electronic Form (eForm), for example position of elements, or control for data validation, setting the default value etc.

To adapt the changing nature of modern business, Electronic Form (eForm) is designed that it can read and display even with different version of Electronic Form (eForm), as long as identifiers are correct, Electronic Form (eForm) allow users to apply minor modification with least training.

Electronic Form (eForm) can cope with Electronic Business Processing Module (eBPM) Generator, allows Electronic Business Processing Module (eBPM) Generator to call and display targeted Electronic Form (eForm) with Electronic Document (eDoc), and also granted the control over sections activities, and capture process time for further computations. And with the Mapping Generator Module, the Electronic Form (eForm) captures data and send to Mapping Generator Module to further process.

The Mapping Generator Module is used to generate and integrate business rules in eSG. Mapping Generator Module is created in fast way through User-Interface (UI). Mapping Generator Module also enable user to set conditions and computations to illustrate the business rule. The business rules are generated in a program and integrate with Electronic Business Processing Module (eBPM) Generator. In convention system, mapping is executed by every single value. In Mapping Generator Module, it can be executed by column (single value) and row based (multiple values).

System Generator Module

The System Generator Module generates forms/modules/components into pre-compiled programs without required extensive analysis works through Electronic Form (eForm). The System Generator Module generates system flow and performs system integration through Electronic Business Processing Module (eBPM). Further, it also generates business rules program through Mapping Module, which can support row and column based data mapping.

The System Generator Module able to generate process control and business rules into pre-compiled Program through Electronic Business Processing Module (eBPM). The System Generator Module enables real time system modification without source code modification. All the business rules, system flow and system validation changes can be done through Electronic Form (eForm) and Electronic Business Processing Module (eBPM).

The System Generator Module uses one standard data storage table design and uses one standard data file system design in all generated system by using a standard name coding structure for all system components.

All of the System Generator Module generated programs are named accordingly to ease for versioning and the generated programs able to support concurrent processing as the Coding structure enables generated system components semantically understandable and eliminates system conflicts.

Electronic Business Processing Module (eBPM) Generator

The Electronic Business Processing Module (eBPM) Generator generates system flow control automatically when user create/edit system flow diagram. The Electronic Business Processing Module (eBPM) Generator also generates every task in workflow to executable programs to reduce system compilation time, where the task is generated into program and store into Electronic Document (eDoc). Furthermore the Electronic Business Processing Module (eBPM) Generator edits, updates and saves any information in document format. This allows user to set the business rules without changing the source code. Business rules can be set or edit in the Electronic Business Processing Module (eBPM) Generator system flow diagram level.

The Electronic Business Processing Module (eBPM) Generator increases the speed of process by reuse the document in system flow. All data is stored in that particular document to be processed by next user. When next user executes the task in the same operational workflow, there is no further data processing to prepare the task. The Electronic Business Processing Module (eBPM) Generator enables user to execute task by loading pre-compiled task program.

Electronic Form (eForm) Generator Module

Electronic Form (eForm) Generator provides a variety of tools that assist user on create a new Electronic Form (eForm) or load and update existing Electronic Form (eForm), for example creation and insertion of elements into Electronic Form (eForm), retrieve existing Predefined Program, data identifier selection etc.

The Electronic Form (eForm) Generator can load Electronic Form (eForm), retrieve and display the design and save the final design as Predefined Program for Electronic Form (eForm). The Electronic Form (eForm) Generator includes controller that will oversee user design for Electronic Form (eForm), and will alert and guide user on creating a valid Electronic Form (eForm), for example duplication control, data identity, Electronic Dictionary (eDict) configuration, to ensure created Electronic Form (eForm) can process data which compatible to Electronic Document (eDoc)design.

The Electronic Form (eForm) Generator also allows user to assign the pre-programmed functions to Electronic Form (eForm) elements and the functions will be triggered according to user's action.

The Electronic Form (eForm) Generator customize normal form elements, to be able to interact with Electronic Dictionary (eDict), each element have its own storage to store its own set of Electronic Dictionary (eDict) data.

Mapping Generator Module

The Mapping Generator Module allows user to generate data mapping program through User Interface (UI), without any source code development by user. The Mapping Generator Module also generates business/mapping rules into executable program, including computation and condition setting. The Mapping Generator Module able to support row based (multiple values) and column based (single value) data mapping.

As illustrated in FIG. 6, the Web processing system will retrieve predefined Program (eProgram) in a Program Module from database and load it into Electronic Form (eForm), which enable data entry of at least one user input (101). Then, the system Check if eDoc available and require to display in eForm (102). If eDoc available, run eDoc loader to retrieve and load eDoc and its data into eForm (103). The eForm's data entry consist of set of rules and tools that assist user on entering valid and useful data, rules include certain type, length, size, value, format and more for entering data, while tools include (eForm functions—LLG) that will perform various action that assist manipulating eForm and eDoc (104). Further, eForm will save all data user entered on the eForm, pass through some checking and verification, and will form these data into an eDoc (105). At this stage, check if current working eForm in flow control by eBpm (106). If the eForm in flow control by eBpm, the eForm will be process by eBpm (107). If the eForm not in flow control by eBpm, the complete eDoc will pass to eBFS to control the flow to store into database (108). Then, eDoc will be pass to TP (Transaction process) to be store into database (109).

As illustrated in FIG. 7, the predefined Program (eProgram) in a Program Module of Web processing module from database and load it into Electronic Form (eForm) further includes steps of; document identifier for loading document (201). Using read module, retrieve predefined Program (eProgram) in a Program Module with document identifier (202). Then, check if the predefined Program (eProgram) in a Program Module exists in database (203). If loading predefined Program (eProgram) in a Program Module is not exists in database, eForm error handler will report faulty to user (204). If loading predefined Program (eProgram) in a Program Module is exists in database, then it retrieved predefined Program (eProgram) by read module, eProgram loader will load the pre-created eProgram into eForm (205).

As illustrated in FIG. 8, the Web processing module initiates the User proceeds to perform data entry by entering data into loaded Electronic Form (eForm) to complete for the transaction or document (301). Electronic Form (eForm) may contains instructions that invoke eForm functions (LLG) to perform various action that may manipulating eForm and processing eDoc, for example load eForm, save eForm, fetching eDoc from database, sum up several targeted elements to targeted element, and etc (302). The data entry by user will go through validation to check these data from a set of rules that pre-defined in the system (303). Then, the system will check if data valid for pre-defined format and rules (304). If data valid for pre-defined format and rules is valid, then for every data which has pre-defined instruction that requesting for data computation, the eForm will compute these data with pre-defined instructions (305).

As illustrated in FIG. 9, the Web processing module will retrieve all data entered in loaded eForm (401). Then, identify these data retrieved to clarify the information on the data, and location of these data will be store (402). These data will go through predefined validation to ensure data are valid information (403). Further, the system checks if data pass through eForm data validation and proven if data is valid (404). With all these data, retrieved, identified and validated, group together and build into eDoc (405). If data is not valid, prompt faulty to user (406).

As illustrated in FIG. 10, the Communication Processing system firstly receiving eDoc to start the process (501). Then, the system will identify the process from row identifier that stated in the eDoc using Retrieval Module (502). Further, validate the process from row identifier (503). If not valid, the system will trigger output error message (504). If valid request, the system will direct eDoc to the requested process for further processing (505).

As illustrated in FIG. 11, the Online Processing system will receive ledger identifier, document identifier, date and time to start the process (601). Then the system will delay the process till the predefined date and time (602). Then, start sum the data of predefined field(s) from eDocs from the predefined document identifier in Transaction eLedger (LT10) and Master eLedger (LM) based on the last processed date and time. The eDocs are retrieved using the Read Module and each field(s) from eDocs are retrieved using the Retrieval Module (603). Thereafter, the system compares the summed value(s) (604). Then, validate if the summed value(s) from LT10 and LM is/are tally (605). If summed value(s) is not tally, locate the missing eDoc in LM from LT10 and store and update the missing eDoc into LM through Transaction Processing Module; the process carries on till the sum is tally (606). However, if summed value(s) tally, update the process completion date and time to the process log (607).

As illustrated in FIG. 12, the Batch Processing system will obtain a batch of eDocs (701). Then, extract pre-summed balance(s) from the batch header for later comparison (702). The sum the data of predefined field(s) from eDocs. Each field(s) from eDocs are retrieved using the Retrieval Module (703). Then, compare the summed value(s) with pre-summed balance(s) (704). Thereafter, validate if the summed value(s) and pre-summed balance(s) is/are tally (705). If summed value(s) and pre-summed balance(s) is/are tally, store the entire batch of eDocs to Transaction Ledger (LT10) and Master Ledger (LM) using Transaction Processing Module (706). However, if summed value(s) and pre-summed balance(s) is/are not tally, the system will prompt output error (707).

As illustrated in FIG. 13, the storage processing system will receiving ledger identifier, document identifier, account 1 and account 2 and eDoc from a program (801). Then, validate with the database if this account is a new account (802). If it's not a new account, retrieve the existing Page from the database for later processing (803). Then, append eDoc form input to the eDoc from Page (804). However, if it's a new account, the system further validate if the length of the combined eDoc is greater than the Page limit (805). If the length of the combined eDoc is greater than Page Limit, chop the combined eDoc into x Pages according to Page limit (806). On the other hand, if the length of the combined eDoc is not greater than Page Limit, each Page Index will be formed base-on document identifier, date, end sequence no, document status, document offset and document length (807). Finally, storing Page and Index into database (808).

As illustrated in FIG. 14, the Storage Processing system used for Indexing will receive document identifier, date, end sequence no, document status, document offset and document length from a program (901). Then, form Index by combining all input as a string and each input is separated by colon (:) (902). Finally, the system returns the formed Index to the program that triggered this operation (903).

As illustrated in FIG. 15, the Storage Processing system used for Reading eDoc from database will receive ledger identifier, document identifier, account 1 and account 2 from a program (1001). Then, retrieve INDEX (indexes) and DATA of Relative Page for a given account from a eFile from the database (1002). Then, parse INDEX into individual index (1003). Thereafter, lookup index that contains document identifier from the input received (1004). The, verify if there is any document identifier is found (1005). if document identifier is not found, validate if there are more indexes (1006). If there are more indexes, lookup index and further verify if there is any document identifier is found. However, if document identifier is found, from the index found, retrieve the offset and the length of the target eDoc. Then extract the eDoc from DATA (1007). Finally, the system output eDoc found (1008).

As illustrated in FIG. 16, BPM Processing system used for User Login Authentication and Process Control requires User to key in username and password as log in details (1101). Then, the System will retrieve the log in details (1102). Then, the system validates the login detail with the login details defined in the database (1103). If the login details are valid, the System retrieves security matrix control setting by using Web-Read Module. The security matrix is user access privileges (read, write, update and delete) on the Document Identifier (1104). Then, the System places control on task by using at least one predefined program (1105).

As illustrated in FIG. 17, the BPM Processing system used for Process Control requires the User selects and enters the application from the menu (1201). Then, the System displays pending and complete task list for user action by using Web-Read Module (1202). Thereafter, the User selects task by using Web-Read Module, where the System checks whether any Document Identifier from previous task, then System will load that particular Document Identifier. If there is no Document Identifier from previous task, System will load the new Document Identifier for user (1203). Then, the System will load the task from Web Processing program (1204). Once user submitted task, System will retrieve eDoc from Web Processing program (1205). Finally, the System will perform save task program (1206).

As illustrated in FIG. 18, the BPM Processing system used for Process Control to retrieve the master process flow information by using Web-Read Module (1301). Thereafter, the system will retrieve the master process flow edoc, the system further validates process flow using Retrieval Module. Then, the System will save user submitted task by using Transaction Processing Module (1302). Then, validate the submitted task by using Web-Read Module (1303). If System identified current task is new task in the workflow, create a new operational workflow ID for this process by using Web-Read Module (1304). However, if System identified current task is not new task in the workflow, System will update current task in operational workflow metering status by using Updating Module. Then, System will save to database by using Transaction Processing Module (1305). In task metering, the System will update task status in the process. Thereafter, the System will retrieve next task setting by using Read Module. Then, System generates the task accordingly and saves to database by using Transaction Processing Module. If next task is Condition, System will perform condition evaluation. If the particular conditions/business rules are valid, System will generate next task and saves to database by using Transaction Processing Module (1306). Then, Validate if task reached end of the process (1307). If current task reached end of the process, System submits and updates all the completed tasks in operational workflow to master Ledger by using Transaction Processing Module and Mapping Module (1308).

As illustrated in FIG. 19, the BPM Processing system used for User Login Authentication and Metering Enquiry requires User to key in username and password as log in details (1401). Then, the System will retrieve the log in details (1402). Then, the System validates the log in detail with the login details defined in the database (1403). Thereafter, the System retrieves security matrix control setting by using Read Module (1404). Finally, the User performs metering enquiry by program (1405).

As illustrated in FIG. 20, the BPM Processing system used for Display metering result and task management enquires, where the User inputs the parameters to enquiry the targeted result. The input parameters examples are workflow ID, user ID, duration and date and save in eDoc format (1501). Then, the System will parse the input by using Retrieval Module then send to enquiry program (1502). Thereafter, the System will generate task metering result based on the enquiry criteria (input parameters). The result will be retrieved by Read Module and display to user (1503). Then, the system Validate if the user selects any task management for assign or unassign task (1504), If user selects task management to assign or unassign task, System will load Manage Job program (1505). However, if user does not select any task management to assign or unassign task, the system will end.

As illustrated in FIG. 21, the BPM Processing systems used for update Task Status by retrieve user role (1601). Then, the System will retrieve user selected task information by using Web-Read Module (1602). Verify if the user would like to update task status (1603). If user updates task status, then System will proceed to update task status by using Updating Module, and then save to database by using Transaction Processing Module. System will perform task status update when user create, execute, update and delete a task (1604). However, if user does not update task status, then verify if user would like to assign or unassign task (1605). If user assigns or unassigns task, System will check user role. In this case, if the current user role rank is authorized, then user is allowed to do task assignment. For example, Manager role rank is higher than Support. If a task can be executed by Support role and above, Manager is allowed to assign the task (1606). Then, the System will update task setting and assign the task to user by using Updating Module, then save to database by using Transaction Processing Module (1607). However, if user does not assign or unassign task, the system further verify if user would like to edit task (1608). If user edits task, System will update task edit details such time, duration and User ID by using Updating Module, then save to database by using Transaction Processing Module (1609). However, If user does not edit task the system terminates.

As illustrated in FIG. 22, The BPM Processing system used for User Login Authentication and System Setting, where, the User needs to key in username and password as log in details (1701). Then, the System will validate the log in details (1702). Verify if log in details is valid (1703). Thereafter, the System retrieves security matrix control setting by using Web-Read Module (1704). Then, User performs system setting control by predefined program (1705).

As illustrated in FIG. 23, the BPM Processing System used for setting up of Setting Control, where, the System will retrieve user role (1801). Thereafter, the System will check is the current user role is Administrator. (1802). If user role is Administrator, user can perform user sign up and security matrix setting. Then, verify if user selected User Control or Document Identifier Access Privileges (1803). If user selected User Control, System will load Sign Up program (1804). If user did not selected User Control, the system further Verify, if user selected set user Document Identifier Access Privileges (1805). Then, if user sets Document Identifier Access Privileges, the System will retrieve selected user security matrix setting by using Retrieval Module (1806). Thereafter, the User can set every Document Identifier Read, Write, View and Delete access privileges by using Updating Module. Then, system submits to database by using Transaction Processing Module (1807). However, If current user role is not Administrator, or if user does not perform Document Identifier Access Privileges, the system terminates.

As illustrated in FIG. 24, the BPM Processing system used for Sign Up new User Account and Edit existing User Account, where, the User inputs and submits the account in eDoc to System (1901). Thereafter, the System will check User ID in account eDoc by using Retrieval Module (1902). Verify if the user would like to perform sign up by determining User ID in submitted account eDoc is empty or if the user would like to perform update user account process, if submitted account eDoc is not empty (1903). However, If User ID in submitted account eDoc is empty, the System will submit the Username in the submitted account eDoc to perform Username existence checking by using Transaction Processing Module (1904). Then, the System will read the result by using Web-Read Module. System parses the result by using Retrival Module. If the Username does not exist, then user is allowed to create a new user account (1905). Then, the System generates the user ID for the new user account and saved in submitted eDoc (1906). However, If User ID in submitted account eDoc is not empty, then the submitted account eDoc is updated in the user account Ledger by using Transaction Processing Module (1907).

As illustrated in FIG. 25, the Enquiry Processing Module used for List and Zoom of document where the system capture users input for ledger identifier and account 1 (2001). Then, the system send request to Enquiry Module (2002). Thereafter, the system retrieves all documents that match criteria (2003). Then, splits into single document and store them temporary (2004). Then, retrieve key information from each documents such as creator, date (2005). Thereafter, the system will populate the documents into a list (2006). Verify if user choose to view or edit column if there is one (2007). If user chosen to view, disable all components and proceed to load the form (2008). However, if user chosen to edit load the form and change action code to editable-mode (M) (2009). Then, the system retrieve document from the temporary storage (2010). Finally, the system display the document (2011).

As illustrated in FIG. 26, the Enquiry Processing System used for process Enquiry where, initially the system receiving ledger identifier and account 1 from a program (2101). Then, the system retrieve INDEX (indexes) and DATA from database based on the input received (2102). Thereafter, parse INDEXes into individual index (2103). Then, lookup eDoc using parsed index (2104). The system further validate if there are more indexes (2105). if there are more indexes found, the system retrieve the offset and the length of the eDoc. Then extract the eDoc from DATA. The process will carry on till there is no more index (2106). Finally, output eDoc(s) found (2107).

As illustrated in FIG. 27, Parallel Processing System used for Parallel Processing of documents where the system receiving instruction either to create 10, 100 or 1000 databases and ledger identifier to be processed from a program (2201). Then, create databases based on the input instruction (2202). Thereafter, distribute eDocs from the defined ledger to databases created using Paging and Index Module. The last, last 2 or last 3 digit(s) of account number is used to determine which database the eDoc to be distributed to (2203). Then, start parallel processing once all eDocs have been distributed into the designated databases (2204). Finally, the system will update the processed result to the predefined Control eLedger through the Mapping Module (2205).

As illustrated in FIG. 28, Mapping Processing System used for Execute Mapping Instruction by receiving source eDoc from a program (2301). Then, parse source eDoc for later operation using Extraction Module (2302). Thereafter, identify and load destination eDoc from the source eDoc (for later updating) using Read Module (2303). Then, load predetermined mapping instructions (2304). validate if there are more mapping instruction (2305). if there are more mapping instruction, the system further validate if the data of the predetermined source column fulfill the predetermined requirement(s) from the mapping instruction (2306). if the data of the predetermined source column fulfill the predetermined requirement(s) from the mapping instruction, then perform computation on the data of the predetermined source column from the mapping instruction if there is one (2307). Thereafter, the system sum up the result from the computation with the data of the predetermined destination column and use the Updating Module to update the final result to the predetermine destination column. This process will be carried on till there is no more mapping instruction (2308). However, if there are no more mapping instruction, then store the updated destination eDoc back into database using Paging and Index Modules (2309).

As illustrated in FIG. 29, the Transaction Processing System used for Processing eDoc Transaction by receiving eDoc from a program (2401). Then, store received eDoc into Transaction eFile using Paging and Indexing Module (2402). Thereafter, update received eDoc to Transaction eLedger using Paging and Indexing Module (2403). Verify if Transaction eLedger updated successfully (2404). if received eDoc updated successfully, the system will store received eDoc into Master eFile using Paging and Indexing Module (2405). Then, update received eDoc to Master eLedger using Mapping Module (2406). Verify if Master eLedger updated successfully (2407). Then, if Master eLedger updated successfully, the system returning the update status (2408).

One Enquiry Program

In legacy systems, there will be a specific enquiry program designed to accommodate to a specific table and this resulting in many enquiry programs being created for many tables. In addition, the enquiry program will have to be changed according the change of the new table design.

By virtue of eDocs are stored in Account-Centric and structure manner (LDSRC coding structure), the eDocs can be retrieved in a direct and fast manner through the one and only one Enquiry Program. The LDSRC coding structure is served as the GIS to the Enquiry Program and it allows the Enquiry Program to easily access to any eLedger (e.g. Human Resource, Stock, etc) to retrieve any eFile or eDoc such as dictionary, library, data and so forth.

Unifying RDBMS

Enterprise Systems usually have multiple RDBMS with different version thus incompatibility amongst databases. It often involves additional planning, design and conversion of databases.

If these can be ONE RDBMS and ONE version of RDBMS, this will be ideal. In reality this is impossible as Enterprise have different companies or a company with different businesses which have different RBDMS. The nearest solution is to have a system that can unify the databases.

The eFiling System is designed to unify RDBMS. eFiling System uses only 3 comment commands of RDBMS which are Read, Write and Index to unify RDBMS. Besides that, Electronic Connector (eConnector) was created to make the communication between different RDBMS possible and even different version amongst the same RDBMS. A Electronic Connector (eConnector) can communicate with n number of RDBMS at any time. The standardized eDict that contains the data, display and condition and computation attributes is applied in order for the eConnector to conform to standard/format of the legacy system.

eDoc End-to-End Compatible

In legacy systems complexity is also introduced with tables as data move between processes e.g. between transmission and storage. The data will be transformed into format that conforms to the next process e.g. from tables to XML format or vice versa.

In enterprise many different RDBMS are employed which require transformation resulting in more tables and processes.

In order for eDoc and eFile to be transmitted between processes without data transformation, the programs at all level have to be eDoc and eFile compatible. The eDoc and eFile is used as standard for the following processes: Web, Transmission, Storage, Batch, Online, BPM, Data Mining and Mapping. Apart from that, the engine to interpret the eDoc and eFile at each process will have to be implemented for System Generator and program generated by the System Generator.

For Storage, eFiling System and eConnector have been implemented to store and to retrieve eDoc and eFile into/from RDBMS.

Over the Web, eBFS is a client side filing system that's designed to handle eDoc and eFile at client-end before passing eDoc or eFile to the Web Process.

Once the data transformation is overcome at database and client level, the eDoc and eFile is transmitted from the Storage to Web process with a single transformation.

At BPM Process, eDoc is used to store graphical drawing of the process flow, process flow (instructions), metering information and generated program. The communication and processes within BPM engine is developed to conform to eDoc standard.

The Mapping Instruction that is constructed in eDoc standard will be transmitted to the Mapping Process to generate a Mapping Program. The generated Mapping Program will be stored into eDoc standard for later retrieval and the processes within the Mapping Program are in eDoc based.

Concurrent Multi-Document

Documents change as business and requirement changes in day to day operation. Thus, this has resulting in the legacy system to have more and more tables being created.

There are multiple version of a document can coexist concurrently thus providing flexibility. Whereas in legacy system, the introduction of a new document will resulting in creating more tables, more enquiry program and even new processes.

The last digit of the document identifier is designed for version controlling. For every new document, the version number is different from the previous. Besides, the program generated to handle the document is also control by the document version number. The program is named after the ledger and document identifier which makes each program unique. Different version of documents and its program can coexist within the system at any point of time. For example, Human Resource (LHR0) may contain a document (D121) and the generated program is named such as LHR0D121.

There is a Control Program that governs which generated program to be load when it's requested by the users. The Control Program will rely on the ledger and document identifier selected by the users to retrieve the right generated program to execute/store data.

Document Conversion

Document conversion from one type to another is challenging and complicated. For two systems to coexist, documents convertor has to be implemented.

Exchange, the one convertor that can convert or encapsulate any document types into eDoc and vice versa which has made the migration of any system to the system fast and hassle free. With the built-in intelligent, the exchange is capable of identifying the data file type stored and if the data stored is corrupted. Apart from that, the table based design system and current system can coexist by using converter to bridge both systems.

System Migration

The system migration in legacy system will always involve changes in form, flow, business rules and code. Furthermore, the system migration process is time consuming and error prone.

To migrate from legacy system to the system, there is no change required in term of form, flow, business rule and code.

The System Generator can replicate the legacy system by retaining the form, flow, business rule and code; a new system is ready to be used without database design and programming involved. With the help of exchange, the documents from legacy system can be converted to the system and this has made the coexistence of both systems possible.

As illustrated in FIG. 30, the System Generator Module initiates once the login authentication by User key in login detail, which are username and password (2501). Then, System will perform validation with the username and password (2502). Validate the login details (2503). Thereafter, retrieve user's security matrix information for further processing, If login detail is valid (2504). Then, System will display the System Generator menu based on user's role, department and security matrix access (2505).

As illustrated in FIG. 31, the User will trigger any menu item to execute particular program (2601). Verify, If eForm is triggered by user (2602). The, System will load eForm predefined program and ends, If eForm is triggered (2603). Thereafter, verify, If eBPM is triggered by user (2604). If eBPM is triggered, System will load eBPM predefined program (2605). Then, verify further If Logout is triggered (2606). The System will update the log out time before the program end, If Logout is triggered by user (2607).

As illustrated in FIG. 32, the Electronic Business Processing Module (eBPM) Generator initiates once the User to selects which program from BPM Menu (2701). Then Verify, If user selection is Loaded (2702). If user selection is Load, System will load the Workflow predefined program and ends (2703). However, If user selection is not Load, then further verify, If user selection is Save (2704). If user selection is Save, System will load Save Workflow program and ends (2705). However, If user selection is not Save, then further verify, If user selection is New (2706). If user selection is New, System will load New Workflow program and ends (2707). However, If user selection is not New, then further verify If user selection is Close (2708). If user selection is Close, System will terminate BPM program (2709).

As illustrated in FIG. 33, the Electronic Business Processing Module (eBPM) Generator initiates once the User selects operation mode and the workflow to be loaded by using Read Module (2801). There are total three operation modes, which are Design, Metering and View. Then, the System will load the selected workflow template based on user selection (2802). Verify, If user selected operation mode is Design (28031). If user selected operation mode is Design, System enable user to enable all tasks properties for edit and ends (2804). However, If user selected operation mode is not Design, the system further Verify, If user selected operation mode is Metering (2805). Then further verify, If user selected operation mode is View (2806). If user selected operation mode is Metering System will check the operational workflow task listing by using Retrieval Module. Then further verify, If user selected task is the first (2807). In Metering mode, System will retrieve first task of the workflow by using Retrieval Module (2808). Then, the workflow is stored in eDoc. Thereafter, the System enables first task to be executed and metering, then ends (2809). However, If user selected task is not the first task In Metering mode, System retrieves the latest task for that particular operational workflow by using Retrieval Module (2810). Then, the System enables latest task to be executed and metering, then ends (2811). On the other hand, If user selected operation mode is View, System will load and disable all tasks in that particular workflow and ends (2812).

As illustrated in FIG. 34, the Electronic Business Processing Module (eBPM) Generator initiates once the User triggers save program (2901). Then, the System will extract system flow information from the workflow diagram (2902). Further, the System will trigger Generate Flow program to perform the flow information extraction (2903). Thereafter, the System will store the extracted system flow information by using Transaction Processing Module (2903). Then, the System also will store the graphical information by using Transaction Processing Module (2904). Finally, the System will generate the program for every task in the workflow, integrate the Electronic Mapping programs and stored it by using Transaction Processing Module (2905).

As illustrated in FIG. 35, the Electronic Business Processing Module (eBPM) Generator initiates by extracting all task components from system flow diagram and store into task list (3001). Verify, If there is more tasks in the list (3002). If there is no more tasks in the list, then the System will compile all tasks and return the master flow list, then ends (3003). However, If there is more tasks in the list, then the System will extract pre task information, such as task type, document identifier and section (3004). Then, the system will extract post task information, such as task type, document identifier and section (3005). Thereafter, the system also extract task properties, such as task name, task description, auto task, pre task data, document identifier, section identifier, user account, role, department and email (3006). Finally, all the extracted information will be inserted into master flow list memory (3007), then verify further, If there is more tasks in the list (3002).

As illustrated in FIG. 36, the Electronic Business Processing Module (eBPM) Generator initiates once the User selects an action to perform (3101). Verify, If Start is selected by user (3102). If Start is selected by user, System generates Start component in Editor (3103). However, if Start is not selected by user, then further verify if End is selected by user (3104). If End is selected by user, System generates End component in Editor (3105). However, if End is not selected by user, then further verify If Task is selected by user (3106). If Task is selected by user, System generates Task component in Editor (3107). Then, user performs Task Setting, then end (3108). However, if Task is not selected by user, then further verify If Condition is selected by user (3109). If Condition is selected by user, System generates Condition component in Editor (3110). User performs Condition Setting, then end (3111). However, if Condition is not selected by user, then further verify If Flow is not selected by user (3112). If Flow is selected by user, System generates Flow component in Editor (3113). Then, User performs source and target components setting, then end (3114). However, if Flow is not selected by user, then further verify If Close is selected by user (3115). If user does not save current workflow, then end (3116). However, If user save current workflow, System perform Save Workflow program (3117).

As illustrated in FIG. 37, the Electronic Form (eForm) Generator initiated by eForm generator to create the interface with tools that assist user on developing eForm into Predefined Program (eProgram), and a blank new eForm with default system elements (3201). Then, the system Check if user wants to load an existing eForm to process (3202). If user wants to load an existing eForm to process, retrieve and load eForm from database through Read Module (3203). Thereafter, the User can create and insert new element into eForm by provided tools on interface of eForm generator (3204). These elements are customized to interact with eDict, so that every element can store a set of eDict that will represent the elements on eForm. Then, the User may configure eDict for elements on eForm by provided tools on interface of eForm generator (3205). Finally, Save eForm design into Predefined Program (eProgram) and store into database (3206).

As illustrated in FIG. 38, the Electronic Form (eForm) Generator initiated by the interface to design and process an eForm, this component create tools that can be use by user to create and insert elements into eForm, configure eDict of eForm elements, retrieve and load existing eForm design from database, etc (3301). Then, Creating a new empty eForm with system default background image (3302). Finally, Creating and insert eForm default system elements into new created eForm, these system elements is important to identify an eForm, to prevent any eForm miss out these elements (3303).

As illustrated in FIG. 39, the Electronic Form (eForm) Generator initiated by Retrieve Predefined Program (eProgram) from database by using read module (3401). Then verify, if loading Predefined Program (eProgram) exists in the database (3402). If loading predefined Program not exists in the database, alert user (3403). However, If loading Predefined Program (eProgram) exist in the database, retrieve and load predefined Program into eForm generator (3404).

As illustrated in FIG. 40, the Electronic Form (eForm) Generator initiated by eForm UI controller which will identify which type of elements user is creating, create elements and insert into eForm (3501). Then, Each created elements serve as a container to capture data with certain identifier that match to format of eDoc, for example data identity and duplication control (3502). Thereafter, the User then configure eDict for elements on eForm by provided tools on interface of eForm design, example of eDict: position of element, condition and computation, maximum and minimum length of characters, maximum and minimum value etc (3503). Finally, eForm functions controller grant control on eForm elements to execute eForm functions on user action (3504).

As illustrated in FIG. 41, the Electronic Form (eForm) Generator initiated by Retrieve all elements from eForm to process (3601). Thereafter, Retrieve and identify data from retrieved eForm elements (3602). Finally, all the retrieved elements and data, the system will build an Predefined Program (eProgram) for future use (3603).

As illustrated in FIG. 42, the Mapping Generator Module will receive the mapping instruction from a Mapping Program; mapping instruction contains mapping level (Row or Column Level), Source and Destination Row Identifier (3701). Thereafter, interpret mapping instruction if the mapping is at Row or Column level (3702). Then, validate if the mapping is at Row level, if there is mapping at Row level (3703). Then the system will retrieve the Source and Destination Row eDicts using Read Module (3704). Then, identify matching Source and Destination Column Name between the Source and Destination Row eDicts retrieved (3705). Then verify, if Source and Destination Column Name are matched. if Source and Destination Column Name are matched (3706). Then the system add the matching Source and Destination Column pair into a temporally list for later processing (3707). However, if Source and Destination Column Name are not matched, then further validate if there are more column to match (3708); if matches the identifying process will continue. However, if there is no mapping at Row level, then further validate if the mapping is at Column level (3709). Then, retrieve the Source and Destination Row eDicts using Read Module, if the mapping is at Column level (3710). Thereafter, from the matching pair(s), the Column Name will be translated into actual index (index of the Column Name in the eDict) by relying on the Row eDict retrieved (3711). Then, generate Mapping Program using the identified Source and Destination index(es) (3712). The Condition and Computation will generated if it's included in the mapping instruction received. Finally, store the generated Mapping Program to the database using Transaction Processing Module (3713).

Data Mining

The data mining will not go through a ETL process and then loaded the data to a Data Warehouse before it is able to mine the data. However, the current Data Mining is able to directly mine the data without going through the conventional process of mining data. Hence, the Data Mining in current system is simple, fast, and near real-time. The advantageous of the current system Data Mining over the legacy system data mining can be summarized as follow: (i) allows for multi-user to data mine data using Account-centric file or ledger. (ii) all Business Data and File in Account-centric File, by customer, by Stock Code, by HR, by General Ledger (GL). The Customer File will contain a complete chronological history of the documents e.g. their application, their invoice, payments etc. and can be used for Detail Analysis. Customers are also linked by group for group analysis. (iii) account-centric Customer File is useful by postcode, and other personal detail. (iv) each Salesman can access his customer details but NOT save a copy because eMS can provide detail info. (v) processing can be distributed and fast. (vi) from the Analysis Data can use different presentation tools. The files are constantly updated and Data Mining can be done in real-time.

Transaction Processing

The Transaction Processing will ensure that any eDocs that are to be stored into the database is Sarbanes-Oxley (SOX) compliance. This is achieved by making sure that the status of each storing and updating process is reported back to Transaction Processing; for this case, eDoc sequence number is used. The process is considered complete when the storing and updating at Transaction eFile and eLedger and Master eFile and eLedger are executed successfully.

Exchange Module

Referring to FIG. 43, an overall process flow of the executing exchange instruction is illustrated. Firstly, retrieve input from user or other system, the input contains data that related in exchange process (3801). Secondly, check the input to determine the mode of the process. The mode includes batch mode or online mode (3802). The batch mode is a mode that runs conversion process to process a large amount of document. Preferably, this mode runs temporary after the system is offline. The online mode is a mode that runs the conversion process in real time. And lastly, convert the file by a Converter Controller (3803). The Converter Controller process contains many file type process including XML, EXCEL, HTML, RDBMS, Table and all other file type (hereinafter referred to as “unreadable file type”). The Converter controller process includes both ways conversion, from other file type to eDoc, and from eDoc to other file type. In addition, other modules such as Retrieval Module, Read Module, Updating Module, String Module, and Transaction Processing Module are provided for use in the conversion process.

Two Systems Data Processing

Referring to FIG. 44, a two system is illustrated. The Two Systems is a further embodiment of the invention utilising the Exchange Module (3903) to enable the possibility of operating the Legacy system (3901) and eMS (3902) concurrently without the need for migrating the system from one to the other. As a result, users of the Legacy system (3901) do not need to change their usual operating method and still able to read or store the data in form of eDoc. The system comprises a Legacy system platform (3901), a eMS platform (3902), and a Exchange Module (3903) connecting the two platforms (3901, 3902) together via a communication network. The two platforms (3901, 3902) are able to receive inputs, data, or instructions from their corresponding user. The Exchange Module (3903) is configured to receive instructions or request from the user, to retrieve data and the right type of converter from the database server, and to perform the conversion of data format based on the requests/instructions. Effectively, the Exchange Module (3903) enables the platforms (3901, 3902) to read data from or write data to the other platform.

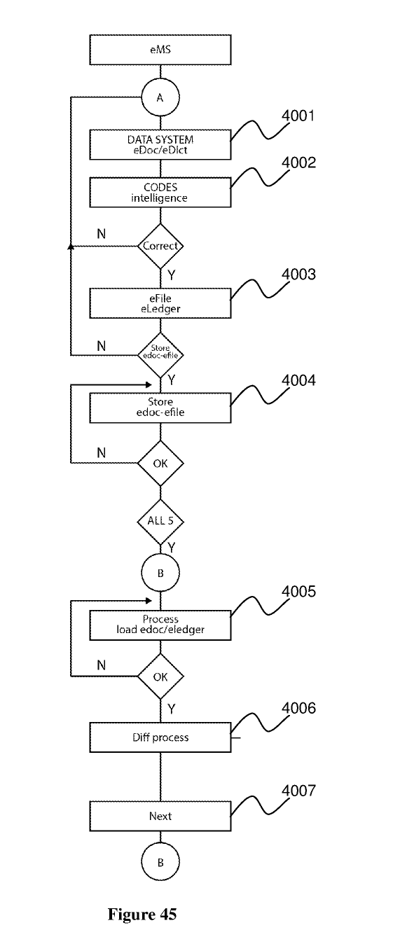

As illustrated in FIG. 45, the system to emulate manual filing system by storing and processing document that operates on Relational Database Management System (RDBMS), comprising; a String Template having at least one details of document number, number of sections and number of rows defined based on at least one Input; a String Module for generate a Electronic Document (eDoc) having at least one Electronic Document Identifier (eDoc-Identifier), Section, Rowtype and Column by validating the document number, number of sections and number of rows based on the String Template; a Extraction Module for extracting the Electronic Document Identifier (eDoc-Identifier), Section, Rowtype and Column of Electronic Document (eDoc) generated by the String Module for retrieval process (4001,4002,4003,4004). Further, a Electronic Form (eForm) Generator Module to create at least one Electronic Form (eForm) having a Predefined Program based on a Electronic Dictionary (eDict) data; a Flow Diagram having pre-compiled task program set by at least one user; a Electronic Business Processing Module (eBPM) Generator to generate at least one task program based on the Flow Diagram to be stored into the Electronic Document (eDoc) (4005); a Mapping Generator Module to generate data mapping program based on a graphical information; a Transaction Processing Module to store the generated Mapping Program; a System Generator Module to generate process control and business rules into pre-compiled program using Electronic Business Processing Module (eBPM); a Virtual Memory for storing the Electronic Document (eDoc); and a Web-Read Module for retrieving the Electronic Document (eDoc) from the Virtual Memory based on at least one identifier of Electronic Document (eDoc), in which the identifier is extracted based on the captured data entry of Electronic Form (eForm) (4005).

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-38. (canceled)

39. A system to emulate a manual filing system by storing and processing document that operates on a relational database management system, comprising:
a string template having at least one detail of a document number, number of sections or number of rows defined based on at least one input;
a string module for generating an electronic document having at least one electronic document identifier, section, rowtype or column by validating the document number, number of sections or number of rows based on the string template;
an extraction module for extracting the electronic document identifier, section, rowtype or column of the electronic document generated by the string module for a retrieval process;
an electronic form generator module to create at least one electronic form having a predefined program based on an electronic dictionary data;
a flow diagram having a pre-compiled task program set by at least one user;
an electronic business processing module generator to generate at least one task program based on the flow diagram to be stored into the electronic document;
a mapping generator module to generate a data mapping program based on graphical information;
a transaction processing module to store the generated mapping program;
a system generator module to generate process control and business rules into the pre-compiled program using the electronic business processing module;
a virtual memory for storing the electronic document;
a web-read module for retrieving the electronic document from the virtual memory based on at least one identifier of the electronic document, in which the identifier is extracted based on the captured data entry of the electronic form; and
an online processing module to ensure that a total sum of the transactions stored in a transaction eLedger is equal to a sum of the transactions stored in a master eLedger.

40. The system according to claim 39, further comprising:
a communication processing module to identify the requested electronic document based on at least one row identifier.

41. The system according to claim 39, further comprising:
a batch processing module to sum the balance of each transaction from a batch of electronic documents and compare the total sum with the pre-summed value from the batch header of electronic documents.

42. The system according to claim 39, wherein the electronic business processing module identifies and assigns at least one task sequence based on master system flow information from a ledger identifier and document identifier and storing into an electronic filing system.

43. The system according to claim 39, further comprising:
a parallel processing module to distribute databases based on the last 2 or 3 digits of an account number.

44. The system according to claim 39, wherein the electronic documents stored into the database are Sarbanes-Oxley compliant.

45. The system according to claim 39, further comprising:
a web processing module to interpret program in a program module based on the electronic form to display the requested electronic document that compatible with loading the electronic form.

46. The system according to claim 39, wherein the web-read module for retrieving the electronic document further comprises:
a paging module having the electronic document append into at least one electronic file in the relational database management system according to a predefined page limit;
an index module having at least one index for the electronic file based on document identifier, date, end sequence number, document status, document offset and document length; and
a read module to obtain the index and at least one data relative page of the electronic file from the index module based on the identifier, in which the electronic document retrieved from the paging module based on the retrieved index and the data relative page to be stored in the virtual memory and update the index module.

47. The system according to claim 40, further comprising:
a storage processing module used for storing transactions into the database through the paging module and index module.

48. The system according to claim 39, further comprising:
an emulating manual system platform connected to the relational table-based design platform through an exchange module via a communication network, wherein the exchange module provides two ways conversion between table-based file format of the relational table-based design platform and electronic document of the emulating manual system platform so that either one of the platforms can process data of the other platform.

49. The system according to claim 40, wherein the identifier of the electronic document comprises a document identifier, date, end sequence number, document status, document offset or document length.

50. The system according to claim 39, wherein a list form has at least one predefined piece of information for each document.

51. The system according to claim 39, further comprising an enquiry module, wherein the enquiry module comprises an editing module to load the retrieved electronic document for updating the retrieved electronic document and storing at least one updated data to the virtual memory.

52. The system according to claim 39, wherein the enquiry module further comprises:
a viewing module to load the retrieved electronic document for viewing the retrieved electronic document.

53. A system according to claim 39, wherein the enquiry module further comprises:
a searching module, wherein the searching module retrieves the electronic document using the web-read module based on at least one index, in which the index is retrieved from the identifier of the electronic document comprising document identifier, date, end sequence number, document status, document offset or document length.

54. A system according to claim 39, wherein the web-read module further comprises:
an uploading module to upload the electronic document based the identifier of the electronic document, wherein the uploading module establishes a connection to at least one server having the relational database management system and updates the relational database management system with the uploaded electronic document.

55. A method to emulate a manual filing system by storing and processing document that operates on a relational database management system, comprising steps of;
creating a template using a string template by defining a new document and indicate number of sections and number of rows required, which will be defined by an input from a user or a database.
generating an electronic document having at least one electronic document identifier, section and rowtype by validating the document number, number of sections and number of rows based on the string template using a string module; and
extracting the electronic document identifier, section and rowtype of the electronic document generated by the string module for retrieval process using an extraction module;
obtaining at least one identifier of the electronic document;
validating if there is at least one electronic document based on the identifier in at least one virtual memory using a web-read module; and
retrieving the validated electronic document from the virtual memory, if there is an electronic document in the virtual memory.

56. The method according to claim 55, further comprising the steps of:
retrieving at least one retrieved data from the data of the electronic document stored in the database based on at least one input of the section, rowtype or column using a retrieval module;
updating the retrieved data of the electronic document and store at least one updated data to the database based on the input of section, rowtype or column defined using an updating module; and
forming the updated electronic document by retrieving the updated data based on the input of section, rowtype or column using a formation module.

57. The method according to claim 557, further comprising the steps of:
providing a mapping module having mapping input;
defining the electronic file location using at least one mapping instruction having a predefined mapping instruction; and
updating the retrieved data of the electronic document using at least one source data.

58. The method according to claim 55, further comprising the steps of:
retrieving the predefined program using a program module from the database;
loading the predefined program it into at least one electronic form to enable data entry of at least one user input;
verifying if the electronic document is available to load the electronic document data in the electronic form based on the user input;
extracting the data entry of user input from the electronic form;
verifying the extracted data entry using a program module based on a set of rules that assist user on entering valid data and a verification tools that assist manipulating the electronic form and electronic document;
saving the verified data into the electronic document;
verifying if the saved electronic document has at least one flow control program defined by the electronic business processing module;
submitting the saved electronic document to the electronic business processing module to define at least one flow control;
transferring the defined electronic document to a transaction processing module to regulate the electronic document to be in Sarbanes-Oxley compliance; and
storing the electronic document into the database.

59. The method according to claim 55, further comprising the steps of:
providing a communication processing module;
receiving the electronic document to start the process;
identifying the process from a row identifier that stated in the electronic document using the retrieval module;
validating the process from the row identifier;
triggering error message, if not valid request; and
directing the electronic document to the requested process, if valid process.

60. The method according to claim 55, further comprising the steps of:
providing an online processing module;
receiving the ledger identifier, document identifier, date and time to start the process;
delaying the process till the predefined date and time;
summing the data of predefined fields from the electronic documents from the predefined document identifier in the transaction eLedger and the master eLedger based on the last processed date and time;
retrieving the electronic document using the read module and each field from the electronic documents are retrieved using the retrieval module;
comparing the summed values;
validating if the summed values from the transaction eLedger and the master eLedger are tallied;
locating the missing electronic document in the master eLedger from the transaction eLedger and store and update the missing electronic document into the master eLedger through the transaction processing module; and
updating the process completion date and time to the process log, if the summed values are tallied.

61. The method according to claim 55, further comprising the steps of:
providing a batch processing module;
obtaining a batch of electronic documents;
extracting the pre-summed balances from the batch header for later comparison;
summing the data of the predefined fields from the electronic documents, wherein each field from the electronic documents are retrieved using the retrieval module;
comparing the summed values with pre-summed balances;
validating if the summed values and pre-summed balances are tallied;
storing the entire batch of electronic documents to the transaction eLedger and the master eLedger using the transaction processing module, if the summed values and pre-summed balances are tallied; and
prompting an output error, if the summed values and pre-summed balances are not tallied.

62. The method according to claim 55, further comprising the steps of:
providing a storage processing module;
obtaining at least one index and at least one data relative page of an electronic file having a document identifier, date, end sequence number, document status, document offset and document length from an index module based on the identifier;
retrieving the electronic document from a paging module based on the index and the data relative page in the relational database management system;
storing the electronic document in the virtual memory; and
updating the index module.

63. The method according to claim 55, further comprising the steps of:
providing an enquiry processing module;
retrieving a plurality of electronic document information based on at least one information for the electronic document identifier, section, rowtype or column of the electronic document using the enquiry processing module; and
displaying the retrieved electronic document information having at least one file history into at least one list form.

64. The method according to claim 55, further comprising the steps of:
providing a parallel processing module;
receiving instructions to create a plurality of databases and ledger identifiers to be processed from a program;
creating databases based on an input instruction;
distributing electronic documents from the defined ledger to databases created based on the last 2 or last 3 digits of account numbers is used to determine which database the electronic document to be distributed to using a paging module and index module;
initiating parallel processing once all the electronic documents have been distributed into the designated databases; and
updating the processed results to a predefined control eLedger through the mapping module.

65. The method according to claim 55, further comprising the steps of:
providing a mapping processing module;
receiving a source electronic document from a program;
parsing the source electronic document for later operation using the extraction module;
identifying and loading a destination electronic document from the source electronic document for later updating using the read module;
loading a predetermined mapping instruction;
validating if there are more mapping instruction;
validating if the data of the predetermined source column fulfill the predetermined requirements from the mapping instruction, if there are more mapping instructions;
performing a computation on the data of the predetermined source column from the mapping instruction, if the data of the predetermined source column fulfill the predetermined requirements from the mapping instruction, then; and
storing the updated destination electronic document back into database using the paging module and index module.

66. The method according to claim 55, further comprising the steps of:
providing a mapping processing module;
receiving the electronic document from a program;
storing the received electronic document into a transaction electronic file using the paging module and indexing module;
updating the received electronic document to the transaction eLedger using the paging module and indexing module;
verifying if the transaction eLedger was updated successfully;
storing the received electronic document into Master electronic file using the paging module and indexing module, if the received electronic document was updated successfully;
updating the received electronic document to the master eLedger using the mapping module;
verifying if the master eLedger was updated successfully; and
returning the update status, if the master eLedger was updated successfully.

67. The method according to claim 55, further comprising the steps of:
obtaining a login authentication based on at least one user input;
validating the login authentication of the user with at least one login details in a database;
retrieving at least one user security matrix information of the valid user stored in the database; and
displaying a menu having at least one list of predefined programs stored in the database based on the user security matrix information.

68. The method according to claim 67, wherein the displaying step further comprises the steps of:
loading at least one electronic business processing module generator having a predefined program, if the user selected from the displayed menu;
loading at least one electronic form generator module having a predefined program, if the user selected from the displayed menu; and
logging out and update the logout request time to the database, if the user selected from the displayed menu.

69. The method according to claim 67, wherein the loading step further comprises the steps of:
displaying a menu having at least one list of predefined program stored in the electronic business processing module generator;
creating at least one workflow program, if the user selected from the displayed menu;
saving the workflow program, if the user selected from the displayed menu;
loading at least one predefined workflow program, if the user selected from the displayed menu; and
exiting the predefined program of the electronic business processing module generator, if the user selected from displayed menu.

70. The method according to claim 69, wherein the creating step further comprises the steps of:
displaying a menu having a start component, end component, condition component, flow component and save component stored in the database;
generating the start component for the workflow program based on the user input, if the user selected from the displayed menu;
generating the end component for the workflow program based on the user input, if the user selected from the displayed menu;
generating at least one condition component for the workflow program based on the user input, if the user selected from the displayed menu;
generating at least one flow component for the workflow program based on the user input, if the user selected from the displayed menu; and
saving the generated components for the workflow program, if the user selected from the displayed menu.

71. The method according to claim 69, wherein the saving step further comprises the steps of:
extracting flow information from the workflow diagram;
generating graphical information from the flow information;
storing the graphical information by using the transaction processing module;
generating a predefined program for at least one task of graphical information;
integrating a mapping information for the task of graphical information using the transaction processing module; and
storing the mapped task using the transaction processing module.

72. The method according to claim 69, wherein the loading step further comprises the steps of:
displaying a menu having a design program, metering program and view program stored in the workflow program;
authorizing the user to edit at least one predefined task property stored in the workflow program, if the user selected the design program from the displayed menu;
verifying the operational workflow for the predefined task using the retrieval module, if the user selected the metering program from the displayed menu; and
displaying all of the predefined tasks, if the user selected the view program from the displayed menu.

73. The method according to claim 71, wherein the integrating step further comprises the steps of:
receiving the mapping instruction from a mapping program;
extracting a mapping instruction contains mapping level, source and destination row identifier;
interpreting the mapping instruction if the mapping is at row or column level of mapping level;
validating if the mapping is at row level;
retrieving a source and destination row electronic dictionaries using the read module, if there is mapping at the row level;
identifying a matching source and destination column name between the retrieved source and destination row electronic dictionaries;
verifying, if the source and destination column name are matched;
adding the matching source and destination column pair into a temporally list, if the source and destination column name are matched;
validating if there are more columns to match;
validating if the mapping is at the column level;
retrieving the source and destination row electronic dictionaries using the read module, if the mapping is at the column level;
translating the column name into actual index based on the row electronic dictionary retrieved;
generating the mapping program using the identified source and destination index;
generating at least one condition and computation based on the mapping instruction received; and
storing the generated mapping program to the database using the transaction processing module.

74. A method for processing data bi-directionally, using a system as claimed in claim 49, comprising the steps of:
receiving a request from either a relational table-based design platform or an emulating manual system platform;
retrieving, by an exchange module, data for conversion from a database server;
retrieving, by the exchange module, a converter from the database server; and
converting, by the exchange module, a format of the retrieved data into a designated format based on the received request.
